(19) United States
(12) Patent Application Publication
(10) Pub. No.: US 2026/0281415 A1
(43) Pub. Date: Sep. 17, 2026

(54) DEPTH MAP CODING FOR THREE-DIMENSIONAL VIDEO

(71) Applicant: QUALCOMM Incorporated, San Diego, CA (US)

(72) Inventors: Xiaoliang BAI, San Diego, CA (US); Ning BI, San Diego, CA (US)

(21) Appl. No.: 19/076,836

(22) Filed: Mar. 11, 2025

(51) Int. Cl. H04N 19/503; G06T 9/00; H04N 19/107

(52) U.S. Cl. CPC H04N 19/503; G06T 9/002; H04N 19/107

(57) ABSTRACT

Systems and techniques are provided for video and depth coding. In some examples, an encoder processes a video frame and a reference depth map (e.g., using a machine learning model) to generate a predicted depth map for the video frame. The encoder identifies an error level between the predicted depth map and a sensor-based depth map, and based on the error level, generates encoded depth video data that includes the video frame an indication of the reference depth map, and/or an error map. In some examples, a decoder decodes, from an encoded dataset, a reference video frame, a reference depth map, a video frame, and information for generating a predicted depth map for the video frame (e.g., indicating the reference depth map). The decoder processes the video frame and depth data corresponding to the information using a machine learning model to generate the predicted depth map.

### FIELD

The present disclosure generally relates to video processing. For example, aspects of the present disclosure relate to systems and techniques for improving video coding techniques (e.g., encoding and/or decoding video) and/or video processing techniques that separate video frame reconstruction operations from post-processing operations to reduce memory usage and improve video decoding speed and efficiency.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Such devices allow video data to be processed and output for consumption. Digital video data includes large amounts of data to meet the demands of consumers and video providers. For example, consumers of video data desire video of the utmost quality, with high fidelity, resolutions, frame rates, and the like. As a result, the large amount of video data that is required to meet these demands places a burden on communication networks and devices that process and store the video data.

Digital video devices can implement video coding techniques to compress video data. Video coding is performed according to one or more video coding standards or formats. For example, video coding standards or formats include versatile video coding (VVC), high-efficiency video coding (HEVC), advanced video coding (AVC), MPEG-2 Part 2 coding (MPEG stands for moving picture experts group), among others, as well as proprietary video codecs/formats such as AOMedia Video 1 (AV1) that was developed by the Alliance for Open Media. Video coding generally utilizes prediction methods (e.g., inter prediction, intra prediction, or the like) that take advantage of redundancy present in video images or sequences. A goal of video coding techniques is to compress video data into a form that uses a lower bit rate, while avoiding or minimizing degradations to video quality. With ever-evolving video services becoming available, coding techniques with better coding efficiency are needed.

### SUMMARY

Systems and techniques are described herein for coding of video data with corresponding depth data. Systems and techniques are provided for coding of video data with corresponding depth data. In some examples, an encoder processes a video frame of a video and a reference depth map (e.g., using a trained machine learning (ML) model) to generate a predicted depth map corresponding to the video frame. In some examples, the encoder compares the predicted depth map to a sensor-based depth map (ground truth depth map) corresponding to the video frame to identify an error level of the predicted depth map. The encoder encodes the video frame, an indication of the reference depth map, and/or an error map (e.g., based on a comparison between the error level and a predetermined threshold) to generate encoded depth video data.

In some examples, a decoder decodes, from an encoded dataset, a reference video frame of a video, a reference depth map corresponding to the reference video frame, a video frame of the video, and information associated with generation of a predicted depth map corresponding to the video frame (e.g., indicating the reference depth map). The encoded dataset includes encoded video data associated with the video and encoded depth data associated with depth data that corresponds to the video. The decoder processes the video frame and the reference depth map corresponding to the information using a trained machine learning model to generate the predicted depth map corresponding to the video frame.

In one example, an apparatus for is provided. The apparatus includes a memory and one or more processors (e.g., implemented in circuitry) coupled to the memory. The one or more processors are configured to and can: process a video frame of a video and a reference depth map to generate a predicted depth map corresponding to the video frame, wherein the reference depth map corresponds to a reference video frame of the video; and encode at least the video frame and an indication of the reference depth map to generate encoded depth video data.

In another example, a method is provided. The method includes: processing a video frame of a video and a reference depth map to generate a predicted depth map corresponding to the video frame, wherein the reference depth map corresponds to a reference video frame of the video; and encoding the video frame an indication of the reference depth map to generate encoded depth video data.

In another example, a non-transitory computer-readable medium is provided that has stored thereon instructions that, when executed by one or more processors, cause the one or more processors to: process a video frame of a video and a reference depth map to generate a predicted depth map corresponding to the video frame, wherein the reference depth map corresponds to a reference video frame of the video; and encode at least the video frame and an indication of the reference depth map to generate encoded depth video data.

In another example, an apparatus is provided. The apparatus includes: means for processing a video frame of a video and a reference depth map to generate a predicted depth map corresponding to the video frame, wherein the reference depth map corresponds to a reference video frame of the video; and means for encoding the video frame an indication of the reference depth map to generate encoded depth video data.

In another example, an apparatus for is provided. The apparatus includes a memory and one or more processors (e.g., implemented in circuitry) coupled to the memory. The one or more processors are configured to and can: decode, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map; decode, from the encoded dataset and based on the indication, the reference depth map corresponding to a reference video frame of the video; and process the video frame and the reference depth map corresponding to the information to generate the predicted depth map corresponding to the video frame.

In another example, a method is provided. The method includes: decoding, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map; decoding, from the encoded dataset and based on the indication, the reference depth map corresponding to a reference video frame of the video; and processing the video frame and the reference depth map corresponding to the information using a trained machine learning model to generate the predicted depth map corresponding to the video frame.

In another example, a non-transitory computer-readable medium is provided that has stored thereon instructions that, when executed by one or more processors, cause the one or more processors to: decode, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map; decode, from the encoded dataset and based on the indication, the reference depth map corresponding to a reference video frame of the video; and process the video frame and the reference depth map corresponding to the information to generate the predicted depth map corresponding to the video frame.

In another example, an apparatus is provided. The apparatus includes: means for decoding, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map; means for decoding, from the encoded dataset and based on the indication, the reference depth map corresponding to a reference video frame of the video; and means for processing the video frame and the reference depth map corresponding to the information using a trained machine learning model to generate the predicted depth map corresponding to the video frame

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus includes an image sensor (e.g., a camera) or multiple image sensors (e.g., multiple cameras) for capturing one or more images. In some aspects, each apparatus includes one or more displays for displaying one or more images, notifications, and/or other displayable data. In some aspects, each apparatus includes one or more speakers, one or more light-emitting devices, and/or one or more microphones. In some aspects, each apparatus described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of an encoding device and a decoding device, in accordance with some examples;

FIG. 2 is a block diagram illustrating an example video encoding device, in accordance with some examples;

FIG. 3 is a block diagram illustrating an example video decoding device, in accordance with some examples;

FIG. 4 is a block diagram illustrating video frames of a video, depth maps corresponding to the video frames, and a depth map delta showing a difference between the depth maps, in accordance with some examples;

FIG. 5 is a block diagram illustrating an effect of applying different compression algorithms to the depth map delta on the accuracy of reconstructing a depth map using the depth map delta, in accordance with some examples;

FIG. 6 is a block diagram illustrating a machine learning (ML) system that includes ML model(s) that process video data and depth data to generate a predicted depth map, in accordance with some examples;

FIG. 7 is a flow diagram illustrating an example of a process for encoding video data and/or depth data, in accordance with some examples;

FIG. 8 is a flow diagram illustrating an example of a process for decoding video data and/or depth data, in accordance with some examples;

FIG. 9 is a block diagram illustrating an example of a neural network that can be used for imaging operations, in accordance with some examples;

FIG. 10 is a flow diagram illustrating an example of a process for encoding video data and/or depth data, in accordance with some examples;

FIG. 11 is a flow diagram illustrating an example of a process for decoding video data and/or depth data, in accordance with some examples; and

FIG. 12 is a block diagram illustrating an example of a computing system that can implement the various techniques described herein, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Video coding devices implement video compression techniques to encode and decode video data efficiently. Video compression techniques may include applying different prediction modes, including spatial prediction (e.g., intra-frame prediction or intra-prediction), temporal prediction (e.g., inter-frame prediction or inter-prediction), inter-layer prediction (across different layers of video data), and/or other prediction techniques to reduce or remove redundancy inherent in video sequences. A video encoder can partition each picture of an original video sequence into rectangular regions referred to as video blocks or coding units (described in greater detail below). These video blocks may be encoded using a particular prediction mode.

Video blocks may be divided in one or more ways into one or more groups of smaller blocks. Blocks can include coding tree blocks, prediction blocks, transform blocks, or other suitable blocks. References generally to a “block,” unless otherwise specified, may refer to such video blocks (e.g., coding tree blocks, coding blocks, prediction blocks, transform blocks, or other appropriate blocks or sub-blocks, as would be understood by one of ordinary skill). Further, each of these blocks may also interchangeably be referred to herein as “units” (e.g., coding tree unit (CTU), coding unit, prediction unit (PU), transform unit (TU), or the like). In some cases, a unit may indicate a coding logical unit that is encoded in a bitstream, while a block may indicate a portion of video frame buffer a process is target to.

For inter-prediction modes, a video encoder can search for a block similar to the block being encoded in a frame (or picture) located in another temporal location, referred to as a reference frame or a reference picture. The video encoder may restrict the search to a certain spatial displacement from the block to be encoded. A best match may be located using a two-dimensional (2D) motion vector that includes a horizontal displacement component and a vertical displacement component. For intra-prediction modes, a video encoder may form the predicted block using spatial prediction techniques based on data from previously encoded neighboring blocks within the same picture.

The video encoder may determine a prediction error. For example, the prediction can be determined as the difference between the pixel values in the block being encoded and the predicted block. The prediction error can also be referred to as the residual. The video encoder may also apply a transform to the prediction error (e.g., a discrete cosine transform (DCT) or other suitable transform) to generate transform coefficients. After transformation, the video encoder may quantize the transform coefficients. The quantized transform coefficients and motion vectors may be represented using syntax elements, and, along with control information, form a coded representation of a video sequence. In some instances, the video encoder may entropy encode the quantized transform coefficients and/or the syntax elements, thereby further reducing the number of bits needed for their representation.

After entropy decoding and de-quantizing the received bitstream, a video decoder may, using the syntax elements and control information discussed above, construct predictive data (e.g., a predictive block) for decoding a current frame. For example, the video decoder may add the predicted block and the compressed prediction error. The video decoder may determine the compressed prediction error by weighting the transform basis functions using the quantized coefficients. The difference between the reconstructed frame and the original frame is called reconstruction error.

As used herein, a “video codec” may be used to refer to software or hardware that compresses and/or decompresses digital video data. For example, a video codec can be used to compress raw video data to reduce file size for storage or transmission, and/or to decompress the video file for playback. Compressing video data may also referred to as “encoding” video data. Decompressing video data may also be referred to as “decoding” video data. Avideo codec IP core can be implemented as a dedicated hardware logic block that is designed for the efficient encoding and decoding (e.g., compression and decompression) of video streams or various other forms of video data. For example, a video codec IP core can be used to perform efficient encoding and decoding operations, and can reduce the power consumption and silicon area needed on-device. The IP core of a video codec IP core can refer to a reusable unit of hardware logic (e.g., a hardware processing block, element, sub-system, etc.) that may be implemented in an integrated circuit, system-on-a-chip (SoC), or other circuitry within a computing device or other apparatus configured to perform video coding. For instance, video codec IP cores can be included in digital video processing systems, and can be integrated into various computing devices such as smartphones, televisions, cameras, etc.

Video coding can be performed according to a particular video coding standard. Examples of video coding standards include, but are not limited to, ITU-T H.261, ISO/IEC MPEG-1 Visual, ITU-T H.262 or ISO/IEC MPEG-2 Visual, ITU-T H.263, ISO/IEC MPEG-4 Visual, Advanced Video Coding (AVC) or ITU-T H.264, including its Scalable Video Coding (SVC) and Multiview Video Coding (MVC) extensions, High Efficiency Video Coding (HEVC) or ITU-T H.265, including its range and screen content coding, 3D video coding (3D-HEVC), multiview (MV-HEVC), and scalable (SHVC) extensions, Versatile Video Coding (VVC) or ITU-T H.266 and its extensions, VP9, Alliance of Open Media (AOMedia) Video 1 (AV1), Essential Video Coding (EVC), among others. Newer generations of video codecs may provide greater compression efficiency, improved video quality, and/or support for higher resolutions and frame rates, etc. For example, more recent video codecs such as HEVC, VP9, VVC, and AV1 can implement more efficient compression that may be used to support applications such as 4K and 8K streaming, etc.

As video coding and video codecs advance to support higher resolutions and frame rates of the video data being encoded and decoded, video codec parallel processing may be utilized. For example, video codec IP cores can implement a plurality of parallel processing pipelines (e.g., also referred to as “pipes”) for parallel encoding and/or decoding of video data. In video codec parallel processing, the task of encoding or decoding video can be divided into smaller, parallel tasks that can be processed simultaneously (e.g., each parallel task can be performed using a corresponding one of the parallel pipes). Distributing a video coding or video processing workload across multiple parallel pipes can reduce an overall processing time for encoding or decoding, and can be used to support higher resolutions of video data, real-time and/or streaming video, etc.

In some examples, each parallel processing pipeline can perform video pixel operations such as motion estimation, motion compensation, transform and quantization, image deblocking, and/or any other video pixel operations. The parallel processing pipelines (and/or each individual processing pipeline) can perform specific video pixel operations in parallel. For example, each processing pipeline can perform multiple operations (and/or process data) simultaneously and/or significantly in parallel. As another example, multiple processing pipelines can perform operations (and/or process data) simultaneously and/or significantly in parallel.

Various video codecs may utilize larger Coding Tree Units (CTUs) and/or may have a larger Largest Coding Unit (LCU) size. Larger LCU sizes can be associated with increasing complexity in balancing video codec workloads in parallel processing architectures. For example, H264 uses an LCU size of 16×16 pixels, while video codecs such as HEVC, VP9, and AV1/VVC use larger LCU sizes up to 128×128 pixels. To process the high pixel throughput associated with ultra-high-resolution content (e.g., such as 8K UHD at 60 frames per second (fps) or 4K UHD at 240 fps, etc.), video codec IP core blocks may utilize parallel processing elements (e.g., such as wavefront processing), with multiple processing pipelines configured to provide increased throughput for higher resolutions and/or higher frame rates.

As a video codec decodes encoded video frames from a bitstream to generate reconstructed video frames, the video codec can store the reconstructed video frames in memory. In some examples, a video codec can store multiple instances of a reconstructed video frame in memory before outputting the reconstructed video frame, for instance by storing a first instance of the reconstructed video frame at the reconstructed resolution without post-processing operation(s) applied, and storing a second instance of the reconstructed video frame at a desired output resolution and/or with post-processing operation(s) applied (e.g., resizing, resampling, rescaling, film grain, color space conversion, format conversion, tone mapping, sharpness adjustment, brightness adjustment, contrast adjustment, color saturation adjustment, other post-processing operations discussed herein, or a combination thereof).

In some examples, a format of the bitstream, and/or which codec is in use, can also cause a memory to store more than one reconstructed video frame in memory, for instance where reconstructing a specific video frame is dependent on data from one or more previously-reconstructed video frames. This effect (e.g., large amount of memory usage) can be exacerbated when a decode order differs from a display order. These aspects, combined, can result in the memory storing a significant amount of data (e.g., a significant number of video frames), for instance including multiple reconstructed video frames and, in some cases, processed variants of one or more of the reconstructed video frames.

Furthermore, as video codecs advance to support higher resolutions and frame rates of the video data being encoded and decoded, the amount of memory needed to store the reconstructed video frames and, in some cases, processed variants thereof, can also increase dramatically. Furthermore, as users move toward smaller portable devices (e.g., phones, watches, rings, glasses, HMDs, wearable devices, and/or other portable devices), space in memory can be increasingly limited in such devices. Thus, there is a need for improved memory management for video coding hardware architectures and/or for video coding operations.

Systems, apparatuses, processes (also referred to as methods), and computer-readable media (collectively referred to as “systems and techniques”) are described herein that can be used to perform video and/or depth coding (e.g., encoding and/or decoding video data and/or depth data) and/or processing of video data and/or depth data.

Systems and techniques are described herein for coding of video data with corresponding depth data. Systems and techniques are provided for coding of video data with corresponding depth data. In some examples, an encoder processes a video frame of a video and a reference depth map (e.g., using a trained machine learning (ML) model) to generate a predicted depth map corresponding to the video frame. In some examples, the encoder compares the predicted depth map to a sensor-based depth map (ground truth depth map) corresponding to the video frame to identify an error level of the predicted depth map. The encoder encodes the video frame, an indication of the reference depth map, and/or an error map (e.g., based on a comparison between the error level and a predetermined threshold) to generate encoded depth video data.

The encoder can improve efficiency of 3D video encoding by reducing the amount of depth data that needs to be encoded to encode the 3D video. For instance, when the predicted depth map (generated by the trained ML model or another depth estimation algorithm) is sufficiently accurate, the codec system does not need to send full depth data for a given frame. Even if error map data is sent, error map data takes up less space than full depth data, or a depth map delta. This can provide technical improvements in efficiency, bandwidth reductions, throughput improvements, reductions in storage space used, improved video quality (e.g., by freeing up more space for higher-resolution video data), or a combination thereof.

In some examples, a decoder decodes, from an encoded dataset, a reference video frame of a video, a reference depth map corresponding to the reference video frame, a video frame of the video, and information associated with generation of a predicted depth map corresponding to the video frame (e.g., indicating the reference depth map). The encoded dataset includes encoded video data associated with the video and encoded depth data associated with depth data that corresponds to the video. The decoder processes the video frame and the reference depth map corresponding to the information using a trained machine learning model to generate the predicted depth map corresponding to the video frame.

The decoder can improve efficiency of 3D video decoding by reducing the amount of depth data that needs to be provided to a decoder to decode the 3D video. For instance, where the predicted depth map (e.g., generated by the trained ML model and/or depth estimation algorithm) is sufficiently accurate, the decoder can generate the reconstructed depth map using only the video frame and the reference depth map. In some cases, if error map data is present in the encoded data, the decoder can generate the reconstructed depth map using only the video frame, the reference depth map, and the error map. Even if error map data is used, error map data takes up less space than full depth data, or a depth map delta. This can provide technical improvements in efficiency, bandwidth reductions, throughput improvements, reductions in storage space used, improved video quality (e.g., by freeing up more space for higher-resolution video data), or a combination thereof. The ability of the decoder to generate reconstructed depth data for a video frame without being provided actual depth data for the video frame can also aid in error handling and/or error correction, for example allowing the decoder to still generate reconstructed depth data in situations where depth data is included but includes error(s), or to still generate reconstructed depth data in situations where depth data was omitted due to an error.

Further aspects of the systems and techniques are described with reference to the figures.

As noted above, the systems and techniques described herein can be applied to any of the existing video codecs, such as Versatile Video Coding (VVC), High Efficiency Video Coding (HEVC), Advanced Video Coding (AVC), Essential Video Coding (EVC), VP9, the AV1 format/codec, and/or other video coding standard, codec, format, etc. in development or to be developed.

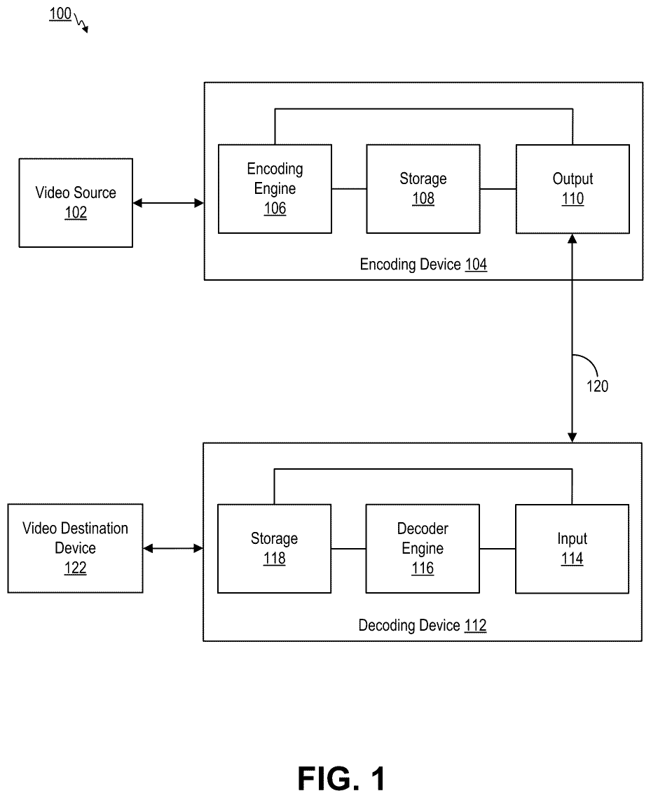

FIG. 1 is a block diagram illustrating an example of a system 100 including an encoding device 104 and a decoding device 112. The encoding device 104 may be part of a source device, and the decoding device 112 may be part of a receiving device. The source device and/or the receiving device may include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the source device and the receiving device may include one or more wireless transceivers for wireless communications. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications. As used herein, the term coding can refer to encoding and/or decoding. In some examples, the system 100 can support one-way or two-way video transmission to support applications such as video conferencing, video streaming, video playback, video broadcasting, gaming, and/or video telephony.

The encoding device 104 (or encoder) can be used to encode video data using a video coding standard, format, codec, or protocol to generate an encoded video bitstream. Examples of video coding standards and formats/codecs include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), including its Scalable Video Coding (SVC) and Multiview Video Coding (MVC) extensions, High Efficiency Video Coding (HEVC) or ITU-T H.265, and Versatile Video Coding (VVC) or ITU-T H.266. Various extensions to HEVC deal with multi-layer video coding exist, including the range and screen content coding extensions, 3D video coding (3D-HEVC) and multiview extensions (MV-HEVC) and scalable extension (SHVC). The HEVC and its extensions have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). VP9, AOMedia Video 1 (AV1) developed by the Alliance for Open Media Alliance of Open Media (AOMedia), and Essential Video Coding (EVC) are other video coding standards for which the techniques described herein can be applied.

The systems and techniques described herein can be applied to any of the existing video codecs (e.g., VVC, HEVC, AVC, or other suitable existing video codec), and/or can be an efficient coding tool for any video coding standards being developed and/or future video coding standards. For example, examples described herein can be performed using video codecs such as VVC, HEVC, AVC, and/or extensions thereof. However, the techniques and systems described herein may also be applicable to other coding standards, codecs, or formats, such as MPEG, JPEG (or other coding standard for still images), VP9, AV1, extensions thereof, or other suitable coding standards already available or not yet available or developed. For instance, in some examples, the encoding device 104 and/or the decoding device 112 may operate according to a proprietary video codec/format, such as AV1, extensions of AV1, and/or successor versions of AV1 (e.g., AV2), or other proprietary formats or industry standards. Accordingly, while the techniques and systems described herein may be described with reference to a particular video coding standard, one of ordinary skill in the art will appreciate that the description should not be interpreted to apply only to that particular standard.

Referring to FIG. 1, a video source 102 may provide the video data to the encoding device 104. The video source 102 may be part of the source device or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures or frames. A picture or frame is a still image that, in some cases, is part of a video. In some examples, data from the video source 102 can be a still image that is not a part of a video. In HEVC, VVC, and other video coding specifications, a video sequence can include a series of pictures. A picture may include three sample arrays, denoted SL, SCb, and SCr. SL is a two-dimensional array of luma samples, SCb is a two-dimensional array of Cb chrominance samples, and SCr is a two-dimensional array of Cr chrominance samples. Chrominance samples may also be referred to herein as “chroma” samples. A pixel can refer to all three components (luma and chroma samples) for a given location in an array of a picture. In other instances, a picture may be monochrome and may only include an array of luma samples, in which case the terms pixel and sample can be used interchangeably. With respect to example techniques described herein that refer to individual samples for illustrative purposes, the same techniques can be applied to pixels (e.g., all three sample components for a given location in an array of a picture). With respect to example techniques described herein that refer to pixels (e.g., all three sample components for a given location in an array of a picture) for illustrative purposes, the same techniques can be applied to individual samples.

The encoder engine 106 (or encoder) of the encoding device 104 encodes the video data to generate an encoded video bitstream. In some examples, an encoded video bitstream (or “video bitstream” or “bitstream”) is a series of one or more coded video sequences. A coded video sequence (CVS) includes a series of access units (AUs) starting with an AU that has a random-access point picture in the base layer and with certain properties up to and not including a next AU that has a random-access point picture in the base layer and with certain properties. For example, the certain properties of a random-access point picture that starts a CVS may include a RASL flag (e.g., NoRaslOutputFlag) equal to 1. Otherwise, a random-access point picture (with RASL flag equal to 0) does not start a CVS. An access unit (AU) includes one or more coded pictures and control information corresponding to the coded pictures that share the same output time. Coded slices of pictures are encapsulated in the bitstream level into data units called network abstraction layer (NAL) units. For example, an HEVC video bitstream may include one or more CVSs including NAL units. Each of the NAL units has a NAL unit header. In one example, the header is one-byte for H.264/AVC (except for multi-layer extensions) and two-byte for HEVC. The syntax elements in the NAL unit header take the designated bits and therefore are visible to all kinds of systems and transport layers, such as Transport Stream, Real-time Transport (RTP) Protocol, File Format, among others.

Two classes of NAL units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. In some cases, a NAL unit can be referred to as a packet. An HEVC AU includes VCL NAL units containing coded picture data and non-VCL NAL units (if any) corresponding to the coded picture data. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). In some cases, each slice or other portion of a bitstream can reference a single active PPS, SPS, and/or VPS to allow the decoding device 112 to access information that may be used for decoding the slice or other portion of the bitstream.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments.

In HEVC, the slices are then partitioned into coding tree blocks (CTBs) of luma samples and chroma samples. A CTB of luma samples and one or more CTBs of chroma samples, along with syntax for the samples, are referred to as a coding tree unit (CTU). A CTU may also be referred to as a “tree block” or a “largest coding unit” (LCU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma component or a chroma component that uses the same motion parameters for inter-prediction or intra-block copy prediction (when available or enabled for use). The luma PB and one or more chroma PBs, together with associated syntax, form a prediction unit (PU). For inter-prediction, a set of motion parameters (e.g., one or more motion vectors, reference indices, or the like) is signaled in the bitstream for each PU and is used for inter-prediction of the luma PB and the one or more chroma PBs. The motion parameters can also be referred to as motion information. A CB can also be partitioned into one or more transform blocks (TBs). A TB represents a square block of samples of a color component on which a residual transform (e.g., the same two-dimensional transform in some cases) is applied for coding a prediction residual signal. A transform unit (TU) represents the TBs of luma and chroma samples, and corresponding syntax elements. Transform coding is described in more detail below.

A size of a CU corresponds to a size of the coding mode and may be square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some examples, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may be quantized by the encoder engine 106.

Once the pictures of the video data are partitioned into CUs, the encoder engine 106 predicts each PU using a prediction mode. The prediction unit or prediction block is subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Intra-prediction utilizes the correlation between spatially neighboring samples within a picture. For example, using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Inter-prediction uses the temporal correlation between pictures in order to derive a motion-compensated prediction for a block of image samples. For example, using inter-prediction, each PU is predicted using motion compensation prediction from image data in one or more reference pictures (before or after the current picture in output order). The decision whether to code a picture area using inter-picture or intra-picture prediction may be made, for example, at the CU level.

The encoder engine 106 and the decoder engine 116 (described in more detail below) may be configured to operate according to VVC. According to VVC, a video coder (such as the encoder engine 106 and/or the decoder engine 116) partitions a picture into a plurality of coding tree units (CTUs) (where a CTB of luma samples and one or more CTBs of chroma samples, along with syntax for the samples, are referred to as a CTU). The video coder can partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels, including a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree partition, a binary tree partition, and one or more types of triple tree partitions. A triple tree partition is a partition where a block is split into three sub-blocks. In some examples, a triple tree partition divides a block into three sub-blocks without dividing the original block through the center. The partitioning types in MTT (e.g., quadtree, binary tree, and tripe tree) may be symmetrical or asymmetrical.

When operating according to the AV1 codec, encoder engine 106 (and/or encoding device 104) and decoder engine 116 (and/or decoding device 112) may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Encoder engine 106 (and/or encoding device 104) may further partition a superblock into smaller coding blocks. Encoder engine 106 (and/or encoding device 104) may partition a superblock and other coding blocks into smaller blocks using square or non-square partitioning. Non-square blocks may include N/2×N, N×N/2, N/4×N, and N×N/4 blocks. Encoder engine 106 (and/or encoding device 104) and decoder engine 116 (and/or decoding device 112) may perform separate prediction and transform processes on each of the coding blocks.

AV1 also defines a tile of video data. A tile is a rectangular array of superblocks that may be coded independently of other tiles. That is, encoder engine 106 (and/or encoding device 104) and decoder engine 116 (and/or decoding device 112) may encode and decode, respectively, coding blocks within a tile without using video data from other tiles. However, encoder engine 106 (and/or encoding device 104) and decoder engine 116 (and/or decoding device 112) may perform filtering across tile boundaries. Tiles may be uniform or non-uniform in size. Tile-based coding may enable parallel processing and/or multi-threading for encoder and decoder implementations.

In some examples, the video coder can use a single QTBT or MTT structure to represent each of the luminance and chrominance components, while in other examples, the video coder can use two or more QTBT or MTT structures, such as one QTBT or MTT structure for the luminance component and another QTBT or MTT structure for both chrominance components (or two QTBT and/or MTT structures for respective chrominance components).

The video coder can be configured to use quadtree partitioning per HEVC, QTBT partitioning, MTT partitioning, or other partitioning structures.

In some examples, the one or more slices of a picture are assigned a slice type. Slice types include an I slice, a P slice, and a B slice. An I slice (intra-frames, independently decodable) is a slice of a picture that is only coded by intra-prediction, and therefore is independently decodable since the I slice requires only the data within the frame to predict any prediction unit or prediction block of the slice. A P slice (uni-directional predicted frames) is a slice of a picture that may be coded with intra-prediction and with uni-directional inter-prediction. Each prediction unit or prediction block within a P slice is either coded with intra prediction or inter-prediction. When the inter-prediction applies, the prediction unit or prediction block is only predicted by one reference picture, and therefore reference samples are only from one reference region of one frame. A B slice (bi-directional predictive frames) is a slice of a picture that may be coded with intra-prediction and with inter-prediction (e.g., either bi-prediction or uni-prediction). A prediction unit or prediction block of a B slice may be bi-directionally predicted from two reference pictures, where each picture contributes one reference region and sample sets of the two reference regions are weighted (e.g., with equal weights or with different weights) to produce the prediction signal of the bi-directional predicted block. As explained above, slices of one picture are independently coded. In some cases, a picture can be coded as just one slice.

As noted above, intra-picture prediction utilizes the correlation between spatially neighboring samples within a picture. There is a plurality of intra-prediction modes (also referred to as “intra modes”). In some examples, the intra prediction of a luma block includes 35 modes, including the Planar mode, DC mode, and 33 angular modes (e.g., diagonal intra-prediction modes and angular modes adjacent to the diagonal intra-prediction modes). The 35 modes of the intra prediction are indexed as shown in Table 1 below. In other examples, more intra modes may be defined including prediction angles that may not already be represented by the 33 angular modes. In other examples, the prediction angles associated with the angular modes may be different from those used in HEVC.

TABLE 1
Specification of intra-prediction mode and associated names

| Intra-prediction mode | Associated name |
|---|---|
| 0 | INTRA_PLANAR |
| 1 | INTRA_DC |
| 2 . . . 34 | INTRA_ANGULAR2 . . . INTRA_ |
| | ANGULAR34 |

Inter-picture prediction uses the temporal correlation between pictures in order to derive a motion-compensated prediction for a current block of image samples. Using a translational motion model, the position of a block in a previously decoded picture (a reference picture) is indicated by a motion vector (Δx, Δy), with Δx specifying the horizontal displacement and Ay specifying the vertical displacement of the reference block relative to the position of the current block. In some cases, a motion vector (Δx, Δy) can be in integer sample accuracy (also referred to as integer accuracy), in which case the motion vector points to the integer-pel grid (or integer-pixel sampling grid) of the reference frame. In some cases, a motion vector (Δx, Δy) can be of fractional sample accuracy (also referred to as fractional-pel accuracy or non-integer accuracy) to more accurately capture the movement of the underlying object, without being restricted to the integer-pel grid of the reference frame. Accuracy of motion vectors may be expressed by the quantization level of the motion vectors. For example, the quantization level may be integer accuracy (e.g., 1-pixel) or fractional-pel accuracy (e.g., ¼-pixel, ½-pixel, or other sub-pixel value). Interpolation is applied on reference pictures to derive the prediction signal when the corresponding motion vector has fractional sample accuracy. For example, samples available at integer positions can be filtered (e.g., using one or more interpolation filters) to estimate values at fractional positions. The previously decoded reference picture is indicated by a reference index (refIdx) to a reference picture list. The motion vectors and reference indices can be referred to as motion parameters. Two kinds of inter-picture prediction can be performed, including uni-prediction and bi-prediction.

With inter-prediction using bi-prediction (also referred to as bi-directional inter-prediction), two sets of motion parameters (Δx₀, y₀, refIdx₀ and Δx₁, Δy₁, refIdx₁) are used to generate two motion compensated predictions (from the same reference picture or possibly from different reference pictures). For example, with bi-prediction, each prediction block uses two motion compensated prediction signals, and generates B prediction units. The two motion compensated predictions are combined to get the final motion compensated prediction. For example, the two motion compensated predictions can be combined by averaging. In another example, weighted prediction can be used, in which case different weights can be applied to each motion compensated prediction. The reference pictures that can be used in bi-prediction are stored in two separate lists, denoted as list 0 and list 1. Motion parameters can be derived at the encoding device 104 using a motion estimation process.

With inter-prediction using uni-prediction (also referred to as uni-directional inter-prediction), one set of motion parameters (Δx₀, y₀, refIdx₀) is used to generate a motion compensated prediction from a reference picture. For example, with uni-prediction, each prediction block uses at most one motion compensated prediction signal, and generates P prediction units.

A PU may include the data (e.g., motion parameters or other suitable data) related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector (Δx), a vertical component of the motion vector (Δy), a resolution for the motion vector (e.g., integer precision, one-quarter pixel precision or one-eighth pixel precision), a reference picture to which the motion vector points, a reference index, a reference picture list (e.g., List 0, List 1, or List C) for the motion vector, or any combination thereof.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, encoding device 104 and decoding device 112 do not use video data from other frames of video data. For most intra prediction modes, the video encoding device 104 encodes blocks of a current frame based on the difference between sample values in the current block and predicted values generated from reference samples in the same frame. The video encoding device 104 determines predicted values generated from the reference samples based on the intra prediction mode.

After performing prediction using intra- and/or inter-prediction, the encoding device 104 can perform transformation and quantization. For example, following prediction, the encoder engine 106 may calculate residual values corresponding to the PU. Residual values may comprise pixel difference values between the current block of pixels being coded (the PU) and the prediction block used to predict the current block (e.g., the predicted version of the current block). For example, after generating a prediction block (e.g., issuing inter-prediction or intra-prediction), the encoder engine 106 can generate a residual block by subtracting the prediction block produced by a prediction unit from the current block. The residual block includes a set of pixel difference values that quantify differences between pixel values of the current block and pixel values of the prediction block. In some examples, the residual block may be represented in a two-dimensional block format (e.g., a two-dimensional matrix or array of pixel values). In such examples, the residual block is a two-dimensional representation of the pixel values.

Any residual data that may be remaining after prediction is performed is transformed using a block transform, which may be based on discrete cosine transform, discrete sine transform, an integer transform, a wavelet transform, other suitable transform function, or any combination thereof. In some cases, one or more block transforms (e.g., sizes 32×32, 16×16, 8×8, 4×4, or other suitable size) may be applied to residual data in each CU. In some examples, a TU may be used for the transform and quantization processes implemented by the encoder engine 106. A given CU having one or more PUs may also include one or more TUs. As described in further detail below, the residual values may be transformed into transform coefficients using the block transforms, and may be quantized and scanned using TUs to produce serialized transform coefficients for entropy coding.

In some examples, following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. The encoder engine 106 may form the TUs including the residual data for the CU, and may transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded video bitstream includes quantized transform coefficients, prediction information (e.g., prediction modes, motion vectors, block vectors, or the like), partitioning information, and any other suitable data, such as other syntax data. The different elements of the coded video bitstream may be entropy encoded by the encoder engine 106. In some examples, the encoder engine 106 may utilize a predefined scan order to scan the quantized transform coefficients to produce a serialized vector that can be entropy encoded. In some examples, the encoder engine 106 may perform an adaptive scan. After scanning the quantized transform coefficients to form a vector (e.g., a one-dimensional vector), the encoder engine 106 may entropy encode the vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

The output 110 of the encoding device 104 may send the NAL units making up the encoded video bitstream data over the communication link 120 to the decoding device 112 of the receiving device. The input 114 of the decoding device 112 may receive the NAL units. The communication link 120 may include a channel provided by a wireless network, a wired network, or a combination of a wired and wireless network. A wireless network may include any wireless interface or combination of wireless interfaces and may include any suitable wireless network (e.g., the Internet or other wide area network, a packet-based network, WiFi, radio frequency (RF), UWB, WiFi-Direct, cellular, Long-Term Evolution (LTE), WiMax, or the like). A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video bitstream data may be modulated according to a communication standard, such as a wireless communication protocol, and transmitted to the receiving device (or recipient device).

In some examples, the encoding device 104 may store encoded video bitstream data in a storage 108. The output 110 may retrieve the encoded video bitstream data from the encoder engine 106 or from the storage 108. The storage 108 may include any of a variety of distributed or locally accessed data storage media. For example, the storage 108 may include a hard drive, a storage disc, flash memory, volatile or non-volatile memory, or any other suitable digital storage media for storing encoded video data. The storage 108 can also include a decoded picture buffer (DPB) for storing reference pictures for use in inter-prediction. In a further example, the storage 108 can correspond to a file server or another intermediate storage device that may store the encoded video generated by the source device. In such cases, the receiving device including the decoding device 112 can access stored video data from the storage device via streaming or download. The file server may be any type of server capable of storing encoded video data and transmitting that encoded video data to the receiving device. Example file servers include a web server (e.g., for a website), an FTP server, network attached storage (NAS) devices, or a local disk drive. The receiving device may access the encoded video data through any standard data connection, including an Internet connection, and may include a wireless channel (e.g., a Wi-Fi connection), a wired connection (e.g., DSL, cable modem, etc.), or a combination of both that is suitable for accessing encoded video data stored on a file server. The transmission of encoded video data from the storage 108 may be a streaming transmission, a download transmission, or a combination thereof.

The input 114 of the decoding device 112 receives the encoded video bitstream data and may provide the video bitstream data to the decoder engine 116, or to the storage 118 for later use by the decoder engine 116. For example, the storage 118 can include a DPB for storing reference pictures for use in inter-prediction. The receiving device including the decoding device 112 can receive the encoded video data to be decoded via the storage 108. The encoded video data may be modulated according to a communication standard, such as a wireless communication protocol, and transmitted to the receiving device. The communication medium for transmitted the encoded video data can comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device to the receiving device.

The decoder engine 116 may decode the encoded video bitstream data by entropy decoding (e.g., using an entropy decoder) and extracting the elements of one or more coded video sequences making up the encoded video data. The decoder engine 116 may rescale and perform an inverse transform on the encoded video bitstream data. Residual data is passed to a prediction stage of the decoder engine 116. The decoder engine 116 predicts a block of pixels (e.g., a PU). In some examples, the prediction is added to the output of the inverse transform (the residual data).

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

In some examples, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device.

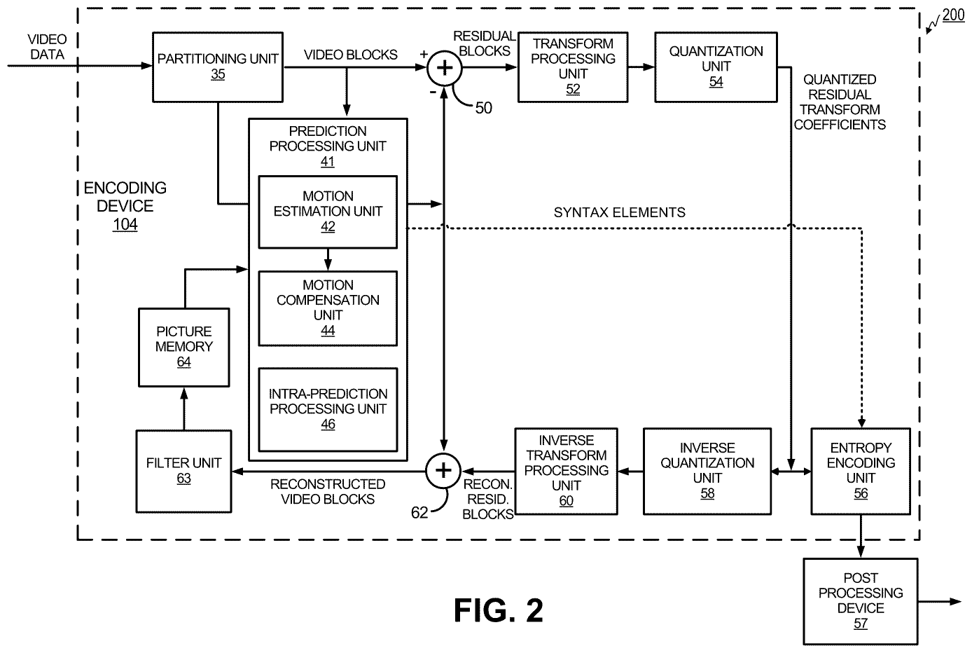

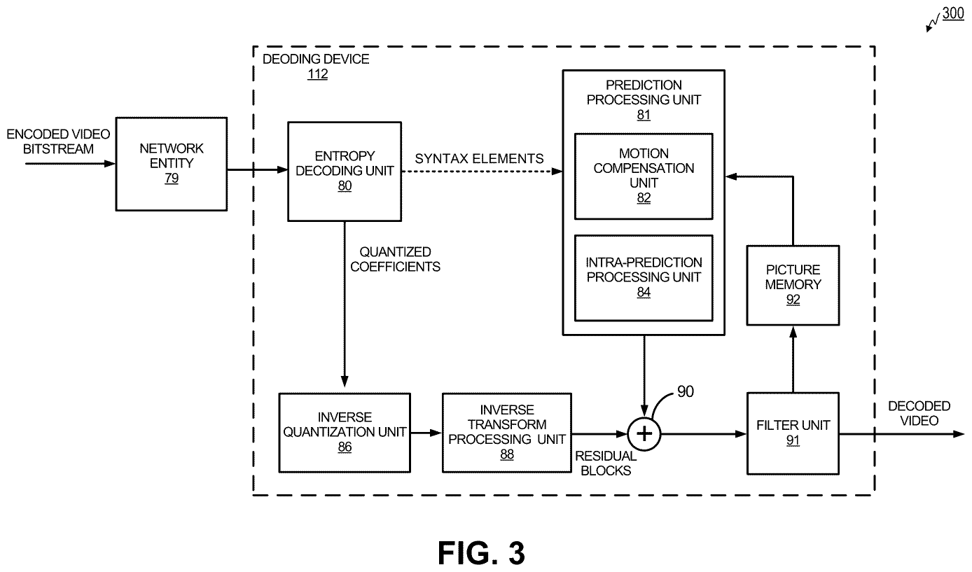

An example of specific details of the encoding device 104 is described below with reference to FIG. 2. An example of specific details of the decoding device 112 is described below with reference to FIG. 3.

The example system shown in FIG. 1 is one illustrative example that can be used herein. Techniques for processing video data using the techniques described herein can be performed by any digital video encoding and/or decoding device. Although generally the techniques of this disclosure are performed by a video encoding device or a video decoding device, the techniques may also be performed by a combined video encoder-decoder, typically referred to as a “CODEC.” Moreover, the techniques of this disclosure may also be performed by a video preprocessor. The source device and the receiving device are merely examples of such coding devices in which the source device generates coded video data for transmission to the receiving device. In some examples, the source and receiving devices may operate in a substantially symmetrical manner such that each of the devices include video encoding and decoding components. Hence, example systems may support one-way or two-way video transmission between video devices, e.g., for video streaming, video playback, video broadcasting, or video telephony.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers usually represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

In general, a layer includes a set of VCL NAL units and a corresponding set of non-VCL NAL units. The NAL units are assigned a particular layer ID value. Layers can be hierarchical in the sense that a layer may depend on a lower layer. A layer set refers to a set of layers represented within a bitstream that are self-contained, meaning that the layers within a layer set can depend on other layers in the layer set in the decoding process, but do not depend on any other layers for decoding. Accordingly, the layers in a layer set can form an independent bitstream that can represent video content. The set of layers in a layer set may be obtained from another bitstream by operation of a sub-bitstream extraction process. A layer set may correspond to the set of layers that is to be decoded when a decoder wants to operate according to certain parameters.

As previously described, an HEVC bitstream includes a group of NAL units, including VCL NAL units and non-VCL NAL units. VCL NAL units include coded picture data forming a coded video bitstream. For example, a sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). Examples of goals of the parameter sets include bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. In some examples, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUs) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some examples, the VPS, SPS, or PPS may be transmitted in-band with the encoded bitstream. In some examples, the VPS, SPS, or PPS may be transmitted out-of-band in a separate transmission than the NAL units containing coded video data.

This disclosure may generally refer to “signaling” certain information, such as syntax elements. The term “signaling” may generally refer to the communication of values for syntax elements and/or other data used to decode encoded video data. For example, the video encoding device 104 may signal values for syntax elements in the bitstream. In general, signaling refers to generating a value in the bitstream. As noted above, video source 102 may transport the bitstream to video destination device 122 substantially in real time, or not in real time, such as might occur when storing syntax elements to storage 108 for later retrieval by the video destination device 122.

Specific details of the encoding device 104 and the decoding device 112 are shown in FIG. 2 and FIG. 3, respectively. FIG. 2 is a block diagram 200 illustrating an example encoding device 104 that may implement one or more of the techniques described in this disclosure. Encoding device 104 may, for example, generate the syntax structures described herein (e.g., the syntax structures of a VPS, SPS, PPS, or other syntax elements). Encoding device 104 may perform intra-prediction and inter-prediction coding of video blocks within video slices. As previously described, intra-coding relies, at least in part, on spatial prediction to reduce or remove spatial redundancy within a given video frame or picture. Inter-coding relies, at least in part, on temporal prediction to reduce or remove temporal redundancy within adjacent or surrounding frames of a video sequence. Intra-mode (I mode) may refer to any of several spatial based compression modes. Inter-modes, such as uni-directional prediction (P mode) or bi-prediction (B mode), may refer to any of several temporal-based compression modes.

The encoding device 104 includes a partitioning unit 35, prediction processing unit 41, filter unit 63, picture memory 64, summer 50, transform processing unit 52, quantization unit 54, and entropy encoding unit 56. Prediction processing unit 41 includes motion estimation unit 42, motion compensation unit 44, and intra-prediction processing unit 46. For video block reconstruction, encoding device 104 also includes inverse quantization unit 58, inverse transform processing unit 60, and summer 62. Filter unit 63 is intended to represent one or more loop filters such as a deblocking filter, an adaptive loop filter (ALF), and a sample adaptive offset (SAO) filter. Although filter unit 63 is shown in FIG. 3 as being an in-loop filter, in other configurations, filter unit 63 may be implemented as a post loop filter. A post processing device 57 may perform additional processing on encoded video data generated by the encoding device 104. The techniques of this disclosure may in some instances be implemented by the encoding device 104. In other instances, however, one or more of the techniques of this disclosure may be implemented by post processing device 57.

As shown in FIG. 2, the encoding device 104 receives video data, and partitioning unit 35 partitions the data into video blocks. The partitioning may also include partitioning into slices, slice segments, tiles, or other larger units, as wells as video block partitioning, e.g., according to a quadtree structure of LCUs (e.g., CTUs) and CUs. The encoding device 104 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra-prediction coding modes or one of a plurality of inter-prediction coding modes, for the current video block based on error results (e.g., coding rate and the level of distortion, or the like). Prediction processing unit 41 may provide the resulting intra- or inter-coded block to summer 50 to generate residual block data and to summer 62 to reconstruct the encoded block for use as a reference picture.

Intra-prediction processing unit 46 within prediction processing unit 41 may perform intra-prediction coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices, or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a prediction unit (PU) of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in picture memory 64. For example, the encoding device 104 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in a reference picture list. The encoding device 104 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by the decoding device 112 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 may select an appropriate intra-prediction mode to use from the tested modes. For example, intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After prediction processing unit 41 generates the predictive block for the current video block via either inter-prediction or intra-prediction, the encoding device 104 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by entropy encoding unit 56, the encoded bitstream may be transmitted to the decoding device 112, or archived for later transmission or retrieval by the decoding device 112. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within a reference picture list. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in picture memory 64. The reference block may be used by motion estimation unit 42 and motion compensation unit 44 as a reference block to inter-predict a block in a subsequent video frame or picture.

In this manner, the encoding device 104 of FIG. 2 represents an example of a video encoder configured to perform the techniques described herein. For instance, the encoding device 104 may perform any of the techniques described herein, including the processes described herein. In some cases, some of the techniques of this disclosure may also be implemented by post processing device 57.

FIG. 3 is a block diagram 300 illustrating an example decoding device 112. The decoding device 112 includes an entropy decoding unit 80, prediction processing unit 81, inverse quantization unit 86, inverse transform processing unit 88, summer 90, filter unit 91, and picture memory 92. Prediction processing unit 81 includes motion compensation unit 82 and intra prediction processing unit 84. The decoding device 112 may, in some examples, perform a decoding pass generally reciprocal to the encoding pass described with respect to the encoding device 104 from FIG. 2.

During the decoding process, the decoding device 112 receives an encoded video bitstream that represents video blocks of an encoded video slice and associated syntax elements sent by the encoding device 104. In some examples, the decoding device 112 may receive the encoded video bitstream from the encoding device 104. In some examples, the decoding device 112 may receive the encoded video bitstream from a network entity 79, such as a server, a media-aware network element (MANE), a video editor/splicer, or other such device configured to implement one or more of the techniques described above. Network entity 79 may or may not include the encoding device 104. Some of the techniques described in this disclosure may be implemented by network entity 79 prior to network entity 79 transmitting the encoded video bitstream to the decoding device 112. In some video decoding systems, network entity 79 and the decoding device 112 may be parts of separate devices, while in other instances, the functionality described with respect to network entity 79 may be performed by the same device that comprises the decoding device 112.

The entropy decoding unit 80 of the decoding device 112 entropy decodes the bitstream to generate quantized coefficients, motion vectors, and other syntax elements. Entropy decoding unit 80 forwards the motion vectors and other syntax elements to prediction processing unit 81. The decoding device 112 may receive the syntax elements at the video slice level and/or the video block level. Entropy decoding unit 80 may process and parse both fixed-length syntax elements and variable-length syntax elements in or more parameter sets, such as a VPS, SPS, and PPS.

When the video slice is coded as an intra-coded (I) slice, intra prediction processing unit 84 of prediction processing unit 81 may generate prediction data for a video block of the current video slice based on a signaled intra-prediction mode and data from previously decoded blocks of the current frame or picture. When the video frame is coded as an inter-coded (e.g., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within a reference picture list. The decoding device 112 may construct the reference frame lists, List 0 and List 1, using default construction techniques based on reference pictures stored in picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by the encoding device 104 during encoding of the video blocks to calculate interpolated values for sub-integer pixels of reference blocks. In this case, motion compensation unit 82 may determine the interpolation filters used by the encoding device 104 from the received syntax elements, and may use the interpolation filters to produce predictive blocks.

Inverse quantization unit 86 inverse quantizes, or de-quantizes, the quantized transform coefficients provided in the bitstream and decoded by entropy decoding unit 80. The inverse quantization process may include use of a quantization parameter calculated by the encoding device 104 for each video block in the video slice to determine a degree of quantization and, likewise, a degree of inverse quantization that should be applied. Inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, the decoding device 112 forms a decoded video block by summing the residual blocks from inverse transform processing unit 88 with the corresponding predictive blocks generated by motion compensation unit 82. Summer 90 represents the component or components that perform this summation operation. If desired, loop filters (either in the coding loop or after the coding loop) may also be used to smooth pixel transitions, or to otherwise improve the video quality. Filter unit 91 is intended to represent one or more loop filters such as a deblocking filter, an adaptive loop filter (ALF), and a sample adaptive offset (SAO) filter. Although filter unit 91 is shown in FIG. 3 as being an in loop filter, in other configurations, filter unit 91 may be implemented as a post loop filter. The decoded video blocks in a given frame or picture are then stored in picture memory 92, which stores reference pictures used for subsequent motion compensation. Picture memory 92 also stores decoded video for later presentation on a display device, such as video destination device 122 shown in FIG. 1.

In this manner, the decoding device 112 of FIG. 3 represents an example of a video decoder configured to perform the techniques described herein. For instance, the decoding device 112 may perform any of the techniques described herein, including the processes described herein.

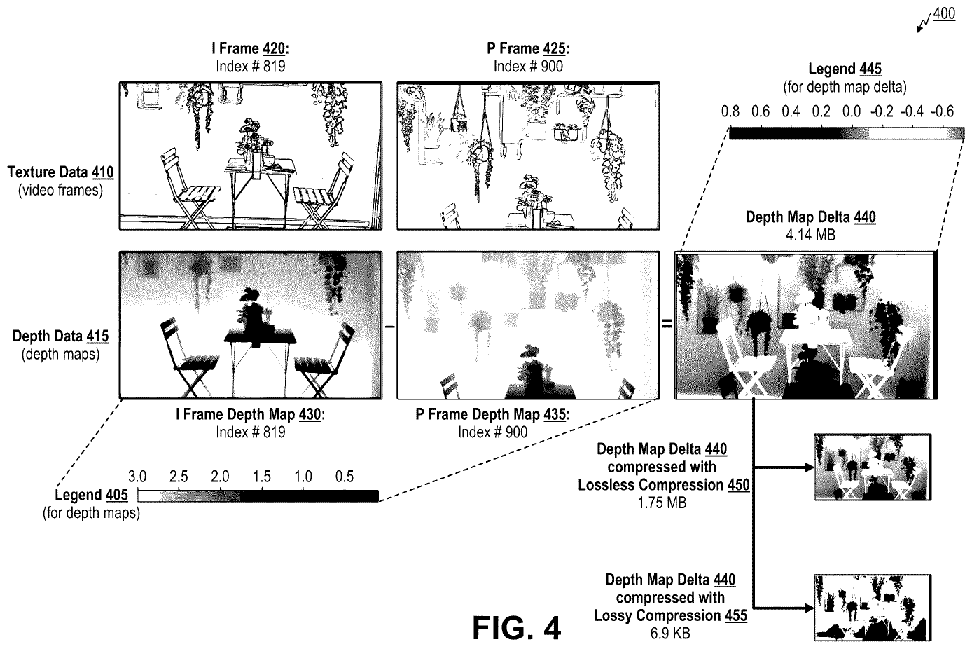

FIG. 4 is a block diagram 400 illustrating video frames of a video (e.g., texture data 410), depth maps (e.g., depth data 415) corresponding to the video frames, and a depth map delta 440 showing a difference between the depth maps.

In some examples, to provide an immersive three-dimensional experience, depth map data can be is used together with video data. Video data, in such scenarios, can be referred to as texture data (e.g., texture data 410). The video data (texture data 410) can include red-green-blue (RGB) image data in the RGB color space, luma-chroma (YUV) image data in the YUV color space, another type of visual data, or a combination thereof. For instance, in the block diagram 400, the texture data 410 includes an I frame 420 with an index number of 819 in a video and a P frame 425 with an index number of 900 in the video. The I frame 420 and the P frame 425 are both images (photos) of a scene with a table, a vase of plants on the table, two chairs on either side of the table, and plants hanging from a wall behind the table.

The depth data 415 in the block diagram 400 includes an I frame depth map 430 corresponding to the I frame 420 (e.g., where the I frame depth map 430 also has the index number of 819 in the video) and a P frame depth map 435 corresponding to the P frame 425 (e.g., where the P frame depth map 435 also has the index number of 900 in the video). A legend 405 identifies that, in the depth data 415, white pixels represent faraway areas (e.g., 3.0 units away from the sensor), black pixels represent close by areas (e.g., 1.0 units away from the sensor), while a gradient of various shades of grey represent areas having distances in between these.

When encoding video data and/or depth data, main frames such as I frames (e.g., the I frame 420, the I frame depth map 430) or key frames are encoded either without compression, or with spatial compression (intra compression) but without temporal compression (inter compression). On the other hand, when encoding video data with depth data non-main frames such as P frames (e.g., the P frame 425, P frame depth map 435) or B frames are encoded with temporal compression (inter compression) and/or spatial compression (intra compression). Under temporal compression (inter compression) of a non-main frame (e.g., the P frame 425, P frame depth map 435), rather than compressing the non-main frame itself, an encoder can compress a delta that shows differences between one video frame or depth map and another video frame or depth map, as in the depth map delta 440 or a video frame delta. A legend 445 for the depth map delta 440 shows that, in the depth map delta 440, grey areas have less error (e.g., 0), black areas have error in a positive direction (e.g., 0.6), and whiter areas have error in a negative direction (e.g., −0.6). In some examples, a codec system can also take advantage of multiview correspondences to further reduce bitrate.

In some examples, encoders can perform temporal compression (inter compression) by compressing motion vectors rather than the frames or deltas. However, because depth values for the same object can (and often do) change at different times, motion-vector-based temporal compression (inter compression) is not as useful for compressing depth maps, and in some cases does causes problems (e.g., does not work) for compressing depth maps.

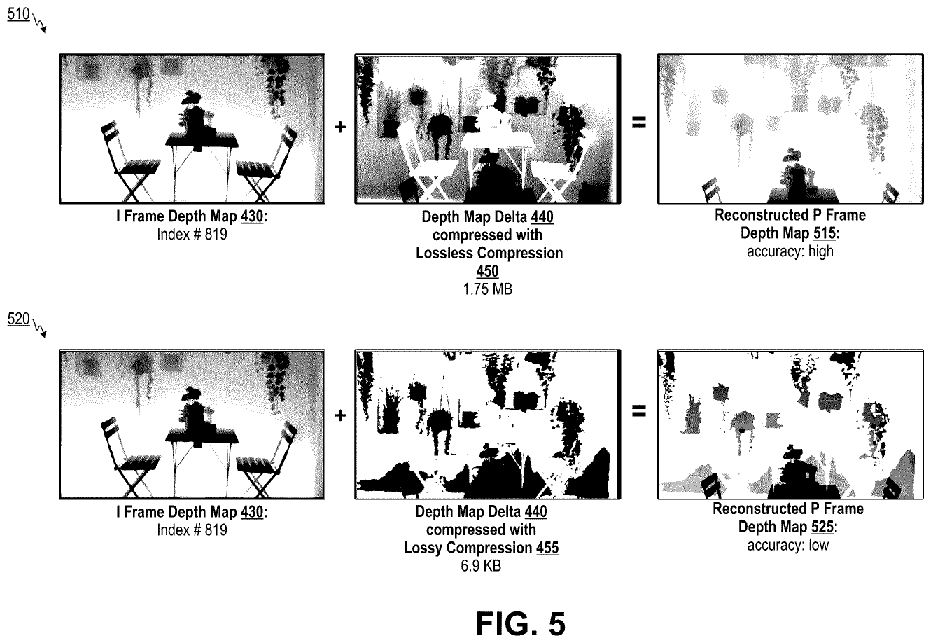

Depth map data is relatively expensive to store and/or transmit (e.g., f32 or uint16 instead of uint8). For instance, the depth map delta 440 illustrated in the block diagram 400 is 4.14 megabytes (MB) in size uncompressed. The depth maps themselves (e.g., the I frame depth map 430 and the P frame depth map 435) have similar sizes. This can quickly add up to very large file sizes for videos, particularly at high resolutions and/or high frame rates. When the depth map delta 440 is compressed using a lossless compression algorithm 450, the resulting compressed depth map delta is still quite large at 1.75 MB. When the depth map delta 440 is compressed using a lossy compression algorithm 455, the resulting compressed depth map delta is quite a bit smaller at 6.9 kilobytes (KB), but can damage the accuracy of the resulting depth maps, as illustrated in FIG. 5.

FIG. 5 is a block diagram illustrating an effect of applying different compression algorithms (e.g., lossless compression algorithm 450 in a first process 510, lossy compression algorithm 455 in a second process 520) to the depth map delta 440 on the accuracy of reconstructing a depth map (the P frame depth map 435) using the depth map delta 440.

In a first process 510, a decoder system combines the I frame depth map 430 (or a decoded, decompressed, and/or reconstructed variant thereof) with the depth map delta 440 as compressed using the lossless compression algorithm 450 (or a decoded, decompressed, and/or reconstructed variant thereof) to generate a reconstructed P frame depth map 515. The reconstructed P frame depth map 515 reconstructs the P frame depth map 435 with a high level of accuracy. However, as noted previously, the depth map delta 440 as compressed using the lossless compression algorithm 450 is still quite large, at 1.75 MB.

In a second process 520, a decoder system combines the I frame depth map 430 (or a decoded, decompressed, and/or reconstructed variant thereof) with the depth map delta 440 as compressed using the lossy compression algorithm 455 (or a decoded, decompressed, and/or reconstructed variant thereof) to generate a reconstructed P frame depth map 525. While the depth map delta 440 as compressed using the lossy compression algorithm 455 is quite small at 6.9 KB, the reconstructed P frame depth map 525 reconstructs the P frame depth map 435 with a low level of accuracy.

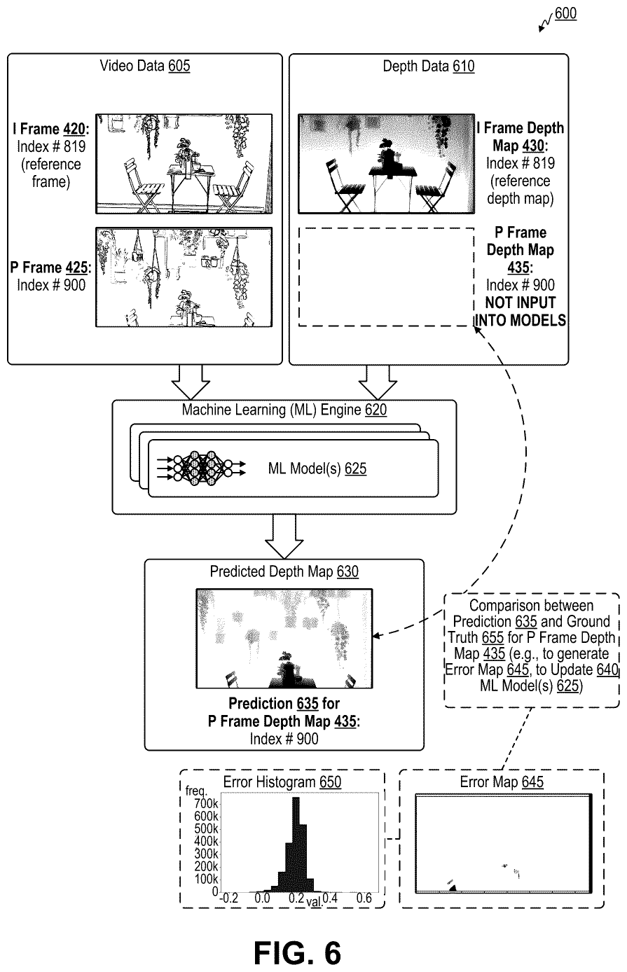

FIG. 6 is a block diagram illustrating a machine learning (ML) system 600 that includes ML model(s) 625 that process video data 605 and depth data 610 to generate a predicted depth map 630. The video data 605 that is input into the ML model(s) 625 can include, for instance, the P frame 425. The depth data 610 that is input into the ML model(s) 625 can include, for instance, the I frame depth map 430, to use as a reference frame. The depth data 610 that is input into the ML model(s) 625 lacks (does not include) the P frame depth map 435. In some examples, the video data 605 that is input into the ML model(s) 625 includes the I frame 420. In some examples, the video data 605 that is input into the ML model(s) 625 lacks (does not include) the I frame 420.

The ML model(s) 625 process the video data 605 (e.g., the P frame 425 and in some cases the I frame 420) and the depth data 610 (e.g., the I frame depth map 430) to generate a prediction 635 of the P frame depth map 435. The prediction 635 can be referred to as a predicted depth map.

The ML model(s) 625 can be a depth map estimator model and/or depth estimator model. The ML model(s) 625 can include, for instance, one or more neural network(s) (NN(s)), one or more convolutional NN(s) (CNN(s)), one or more time delay NN(s) (TDNN(s)), one or more deep network(s) (DN(s)), one or more autoencoder(s) (AE(s)), one or more variational autoencoder(s) (VAE(s)), one or more deep belief net(s) (DBN(s)), one or more recurrent NN(s) (RNN(s)), one or more generative adversarial network(s) (GAN(s)), one or more conditional GAN(s) (cGAN(s)), one or more feed-forward network(s), one or more network(s) having fully connected layers, one or more support vector machine(s) (SVM(s)), one or more random forest(s) (RF), one or more computer vision (CV) system(s), one or more autoregressive (AR) model(s), one or more Sequence-to-Sequence (Seq2Seq) model(s), one or more large language model(s) (LLM(s)), one or more deep learning system(s), one or more classifier(s), one or more transformer(s), or a combination thereof. The ML model(s) 625 can be an example of the neural network 900, or vice versa.

In some examples, the ML model(s) 625 can include a U-Network (U-Net) structure and/or architecture that includes a contracting path and an expansive path. If the ML model(s) 625 is a U-Net, the ML model(s) 625 may include, for instance, combination of convolution, up-convolution, pooling and skip connections that allows the ML model(s) 625 to extract and capture complex features, while also keeping and reconstructing spatial information.

In examples where the ML model(s) 625 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

Within FIG. 6, a graphic representing the ML model(s) 625 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 625 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 625 can include a feed-forward network, in which case there are no feedback connections where outputs of the network are fed back into itself. In some cases, the ML model(s) 625 can include a recurrent neural network, which can have loops that allow information to be carried across nodes while reading in input. In some cases, the network can include a convolutional neural network, which may not link every node in one layer to every other node in the next layer.

In some examples, once the ML model(s) 625 generates the prediction 635 of the P frame depth map 435, a system (e.g., the ML system 600, the ML engine 620, or another system) can compare the prediction 635 to a ground truth 655 for the P frame depth map 435, for instance to generate an error map 645 and/or an error histogram 650, to perform an update 640 to the ML model(s) 625 based on the comparison (e.g., fine-tuning and/or further training of the ML model(s) 625 based on the error map 645, the error histogram 650, and/or other aspects of the comparison).

The ML engine 620 of the ML system can update (further train) the ML model(s) 625 based on the comparison (e.g., the error map 645 and/or the error histogram 650) to perform an update 640 (e.g., further training and/or fine-tuning) of the ML model(s) 625 based on the comparison. In some examples, the comparison is positive, for instance indicating that the prediction 635 closely aligns with the ground truth 655 (e.g., with an error level less than a threshold). In some examples, the comparison is negative, for instance indicating a mismatch between the prediction 635 and the ground truth 655 (e.g., error level exceeding a threshold).

In response to a positive comparison, the ML engine 620 can perform the update 640 to update the ML model(s) 625 to strengthen and/or reinforce weights (and/or connections and/or hyperparameters) associated with generation of the prediction 635 to encourage the ML engine 620 to generate similar predictions given similar input(s) (e.g., the video data 605, the depth data 610). In this way, the update 640 can improve the ML model(s) 625 itself by improving the accuracy of the ML model(s) 625 in generating predictions that are similarly accurate (to the prediction 635) given similar input(s) (e.g., the video data 605, the depth data 610). In response to a negative comparison, the ML engine 620 can perform the update 640 to update the ML model(s) 625 to weaken and/or remove weights (and/or connections and/or hyperparameters) associated with generation of the prediction 635 to discourage the ML engine 620 from generating similar predictions (to the prediction 635) given similar input(s) (e.g., the video data 605, the depth data 610). In this way, the update 640 can improve the ML model(s) 625 itself by improving the accuracy of the ML model(s) 625 in generating predictions are more accurate (than the prediction 635) given similar input(s) (e.g., the video data 605, the depth data 610). In some examples, for instance, the update 640 can improve the accuracy of the ML model(s) 625 in generating predicted depth maps by reducing false positive(s) and/or false negative(s) in the prediction 635.

In some examples, training of the ML model(s) 625 (e.g., as in the update 640) is supervised at an initial training stage. In some examples, training of the ML model(s) 625 (e.g., as in the update 640) is self-supervised at a second stage, for instance updating the ML model(s) 625 based on comparisons (e.g., error map 645, error histogram 650) between the prediction 635 and the ground truth 655.

In some examples, the ML model(s) 625 can include an ensemble of multiple ML models, and the ML engine 620 can curate and manage the ML model(s) 625 in the ensemble. The ensemble can include ML model(s) 625 that are different from one another to produce different respective outputs, which the ML engine 620 can average (e.g., mean, median, and/or mode) to identify the prediction 635. In some examples, the ML engine 620 can calculate the standard deviation of the respective outputs of the different ML model(s) 625 in the ensemble to identify a level of confidence in the prediction 635. In some examples, the standard deviation can have an inverse relationship with confidence. For instance, if the respective outputs of the different ML model(s) 625 are very different from one another (and thus have a high standard deviation above a threshold), the confidence that the prediction 635 is accurate may be low (e.g., below a threshold). On the other hand, if the respective outputs of the different ML model(s) 625 are equal or very similar to one another (and thus have a low standard deviation below a threshold), the confidence that the prediction 635 is accurate may be high (e.g., above a threshold).

In some examples, different ML models(s) 625 in the ensemble can include different types of models. For instance, in some examples, an ensemble can include a NN and a SVM that are both trained to process the input(s) (e.g., video data 605, depth data 610) to generate the prediction 635. In some examples, the ensemble may include different ML model(s) 625 that are trained to process different inputs of the input(s) (e.g., video data 605, depth data 610) and/or to generate different aspects of the prediction 635. In some examples, the ML engine 620 can choose specific ML model(s) 625 to be included in the ensemble because the chosen ML model(s) 625 are effective at accurately processing particular types of input(s) (e.g., video data 605, depth data 610), are effective at accurately generating particular types of outputs, are generally accurate, process input(s) (e.g., video data 605, depth data 610) quickly, generate outputs quickly, are computationally efficient, have higher or lower degrees of uncertainty than other models in the ensemble, or a combination thereof.

In some examples, one or more of the ML model(s) 625 can be initialized with weights, connections, and/or hyperparameters that are selected randomly. This can be referred to as random initialization. These weights, connections, and/or hyperparameters are modified over time through training (e.g., initial training with the training data and/or update(s) 640 based on the comparison), but the random initialization can still influence the way the ML model(s) 625 process data, and thus can still cause different ML model(s) 625 (with different random initializations) to produce different outputs (e.g., different variants of the prediction 635). Thus, in some examples, different ML model(s) 625 in an ensemble can have different random initializations.

As an ML model (of the ML model(s) 625) is trained (e.g., along the initial training with the training data, update(s) 640 based on the comparisons, and/or other modification(s)), different versions of the ML model at different stages of training can be referred to as checkpoints. In some examples, after each new update to a model (e.g., update 640) generates a new checkpoint for the model, the ML engine 620 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 620 produces a benchmark score for one or more checkpoint(s) of one or more ML model(s) 625, and keeps the checkpoint(s) that have the best (e.g., highest or lowest) benchmark scores in the ensemble. In some examples, if a new checkpoint is worse than an older checkpoint, the ML engine 620 can revert to the older checkpoint. The benchmark score for a can represent a level of accuracy of the checkpoint and/or number of errors (e.g., false positive or false negative) by the checkpoint during the testing (e.g., against the testing data and/or the validation data). In some examples, an ensemble of the ML model(s) 625 can include multiple checkpoints of the same ML model.

In some examples, the ML model(s) 625 can be modified, either through the initial training (with training data), an update 640 based on the comparison, or another modification to introduce randomness, variability, and/or uncertainty into an ensemble of the ML model(s) 625. In some examples, such modification(s) to the ML model(s) 625 can include dropout (e.g., Monte Carlo dropout), in which one or more weights or connections are selected at random and removed. In some examples, dropout can also be performed during inference, for instance to modify the output(s) (e.g., prediction 635) generated by the ML model(s) 625. The term Bayesian Machine Learning (BML) can refer to random dropout, random initialization, and/or other randomization-based modifications to the ML model(s) 625. In some examples, the modification(s) to the ML model(s) 625 can include a hyperparameter search and/or adjustment of hyperparameters. The hyperparameter search can involve training and/or updating different ML models 625 with different values for hyperparameters and evaluating the relative performance of the ML models 625 (e.g., against testing data and/or validation data where the correct output(s) are known) to identify which of the ML models 625 performs best. Hyperparameters can include, for instance, temperature (e.g., influencing level creativity and/or randomness), top P (e.g., influencing level creativity and/or randomness), frequency penalty (e.g., to prevent repetitive language between one of the prediction 635 and another), presence penalty (e.g., to encourage the ML model(s) 625 to introduce new data in the prediction 635), other parameters or settings, or a combination thereof.

In some examples, instead of using the ML model(s) 625 and/or the ML engine 620 to process the video data 605 and the depth data 610 to generate the predicted depth map 630, another type of depth estimation algorithm is used to process the video data 605 and/or the depth data 610 to generate the predicted depth map 630. For instance, examples of such a depth estimation algorithm (that is not the ML model(s) 625 and/or the ML engine 620) can include stereo vision algorithms, structure from motion algorithms, perspective projection algorithms, texture gradient analysis algorithms, occlusion relationship analysis algorithms, semantic segmentation algorithms, semantic mapping algorithms, or a combination thereof.

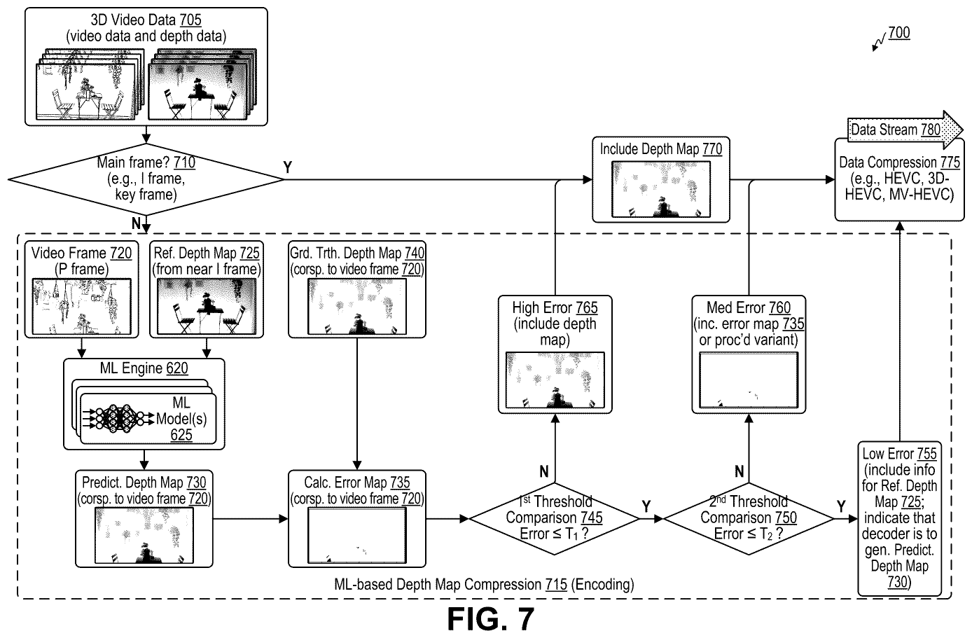

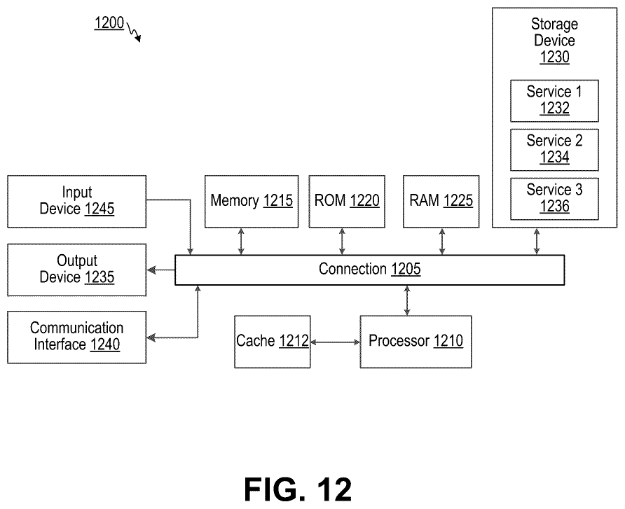

FIG. 7 is a flow diagram illustrating an example of a process 700 for encoding video data and/or depth data. The process 700 is performed by an encoder system, which may include the system 100, video source 102, the encoding device 104, decoding device 112, the communication link 120, the video destination device 122, the decoder system that reconstructs the reconstructed P frame depth map 515, the decoder system that reconstructs the reconstructed P frame depth map 525, the ML system 600, the ML engine 620, the ML model(s) 625, the decoder system that performs the process 800, the neural network 900, the codec system that performs the process 1000, the codec system that performs the process 1100, the computing system 1200 of FIG. 12, a computing device, a processor executing instructions stored in a memory, a processor executing instructions stored in a non-transitory computer-readable storage medium, a component of sub-system of any of these systems, a head-mounted display (HMD), a headset, a mobile handset, a wireless communication device, a wearable device, a component or system (e.g., a chipset, one or more processors such as one or more central processing units (CPUs), digital signal processors (DSPs), graphics processing units (GPUs), any combination thereof, and/or other type of processor(s), or other component or system) of any of the previously listed systems, or a combination thereof.

The process 700 takes advantage of the ability of the ML model(s) 625 to generate accurate predicted depth maps (e.g., as in the prediction 635 of the P frame depth map 435 illustrated in FIG. 6) to reduce how much data (in terms of file size) is encoded in the encoded data stream 780 output by the encoder system, by determining when the encoder can instruct the decoder to generate a predicted depth map for a frame using the ML model(s) 625 rather than storing expensive depth map deltas (e.g., depth map delta 440).

To perform the process 700, the encoder system receives three-dimensional (3D) video data 705, which includes video data (e.g., texture data 410, video data 605) and depth data (e.g., depth data 415, depth data 610) that corresponds to the video data. At operation 710, the encoder system determines whether a given frame (e.g., video frame and corresponding depth map from the same index and/or timestamp) of a video is a main frame (e.g., an I frame or a key frame) or not. If, at operation 710, the encoder system determines that the given frame is a main frame (e.g., as in the I frame 420 and/or the I frame depth map 430), then at operation 770, the encoder system includes the depth map from the given frame in the encoded data stream 780 after performing data compression 775 on the given frame (e.g., the video frame and the corresponding depth map). The data compression 775 can include compression using a High Efficiency Video Coding (HEVC), compression using a three-dimensional HEVC (3D-HEVC), compression using a multi-view HEVC (MV-HEVC), compression using another compression algorithm, or a combination thereof.

If, at operation 710, the encoder system determines that the given frame is not a main frame—for instance, the given frame is a P frame (e.g., P frame 425 and/or P frame depth map 435) or B frame rather than an I frame or a key frame—then the encoder system performs an ML-based depth map compression 715. In the ML-based depth map compression 715, the encoder system splits the given frame into the video frame 720 (P frame) and the ground truth depth map 740 (corresponding to the video frame 720, for instance sharing the same index and/or timestamp in the video). For instance, the P frame 425 can be an example of the video frame 720, and the P frame depth map 435 (and/or the ground truth 655 for the P frame depth map 435) can be an example of the ground truth depth map 740.

The encoder system also retrieves the depth map of a nearby (e.g., the nearest) main frame to the video frame 720 (e.g., in terms of index and/or timestamp in the video). This depth map is referred to as the reference depth map 725. In some examples, the encoder system also retrieves nearby (e.g., the nearest) main frame to the video frame 720 itself, which can be referred to as the reference video frame. The I frame 420 can be an example of the reference video frame. The I frame depth map 430 can be an example of the reference depth map 725.

The encoder system processes at least the video frame 720 and the reference depth map 725 using the ML model(s) 625 to generate a predicted depth map 730. In some examples, the encoder system processes the video frame 720, the reference video frame, and the reference depth map 725 using the ML model(s) 625 to generate the predicted depth map 730. The predicted depth map 730 corresponds in time (e.g., index or timestamp in the video) to the video frame 720. The prediction 635 of the P frame depth map 435 (corresponding to the P frame 425) is an example of the predicted depth map 730 (corresponding to the video frame 720).

In some examples, encoder system compares the predicted depth map 730 to the ground truth depth map 740 to calculate (generate) an error map 735 indicating differences between the predicted depth map 730 to the ground truth depth map 740. The error map 645 can be an example of the error map 735. In some examples, the encoder system calculates an error level based on the error map 735. For instance, the error level can be an average (e.g., mean, median, and/or mode) error across the pixels of the error map 735, a sum of the errors across the pixels of the error map 735, a maximum error across the pixels of the error map 735, a minimum error across the pixels of the error map 735, or a combination thereof. In some examples, the encoder system calculates an error level instead of calculating the error map 735.

At operation 745, the encoder system compares the error level to a first threshold T₁. If, at operation 745, the encoder system determines that the error level is greater than (or equal to) the first threshold T₁, then, at operation 765, the encoder system, determines that the error level is too high to instruct the decoder to use the ML model(s) 625 to generate the predicted depth map 730. Instead, the encoder system proceeds from operation 765 to operation 770, where the encoder system includes the depth map from the given frame in the encoded data stream 780 after performing data compression 775 on the given frame (e.g., the video frame and the corresponding depth map), similarly to if the video frame 720 was a main frame (as checked in operation 710). If, at operation 745, the encoder system determines that the error level is less than (or equal to) the first threshold T₁, then the encoder system moves on to operation 750.

At operation 750, the encoder system compares the error level to a second threshold T₂. If, at operation 750, the encoder system determines that the error level is less than (or equal to) the second threshold T₁, then the encoder system moves on to operation 755. At operation 755, the encoder system determines that the error level is sufficiently low to omit the depth map from the encoded data stream 780, instead instructing the decoder to generate the predicted depth map 730 using the ML model(s) 625, and including (in the encoded data stream 780) an identifier of the reference depth map 725 (e.g., an index or timestamp in the video corresponding to the reference depth map 725 so that the decoder knows which reference depth map 725 to input into the ML model(s) 625), compressed via the data compression 775.

If, at operation 750, the encoder system determines that the error level is greater than (or equal to) the second threshold T₂, then, at operation 760, the encoder system determines that the error level is medium (T₂≤error≤T₁), and the encoder system moves on to operation 760. At operation 760, the encoder system includes, in the encoded data stream 780 (e.g., compressed via the data compression 775), the identifier of the reference depth map 725, an error map or an error correction map, and instructions to the decoder to generate the predicted depth map 730 using the ML model(s) 625 and to modify the predicted depth map 730 using the error map or error correction map. Once the decoder processes the video frame 720 and the identifier of the reference depth map 725 to generate the predicted depth map 730, the encoder system can modify the predicted depth map 730 according to the error map or error correction map to correct the error(s) in the predicted depth map 730. In some examples, the error map or error correction map that is included in the encoded data stream 780 is the error map 735. In some examples, an error correction map is generated based on the error map 735 (e.g., inverting aspects of the error map 735 to show how to correct the errors of the predicted depth map 730), and the error correction map is included in the encoded data stream 780 (compressed via the data compression 775). In some examples, a filtered or otherwise processed variant of the error map 735 and/or error correction map is included in the encoded data stream 780 (compressed via the data compression 775).

In some examples, instead of using the ML model(s) 625 and/or the ML engine 620 to process the video frame 720 and the reference depth map 725 to generate the predicted depth map 730, another type of depth estimation algorithm is used to process the video frame 720 and/or the reference depth map 725 to generate the predicted depth map 730. For instance, examples of such a depth estimation algorithm (that is not the ML model(s) 625 and/or the ML engine 620) can include stereo vision algorithms, structure from motion algorithms, perspective projection algorithms, texture gradient analysis algorithms, occlusion relationship analysis algorithms, semantic segmentation algorithms, semantic mapping algorithms, or a combination thereof.

In some examples, the error map 735 can be calculated and/or generated using the ML model(s) 625, the ML engine 620, and/or another machine learning model system.

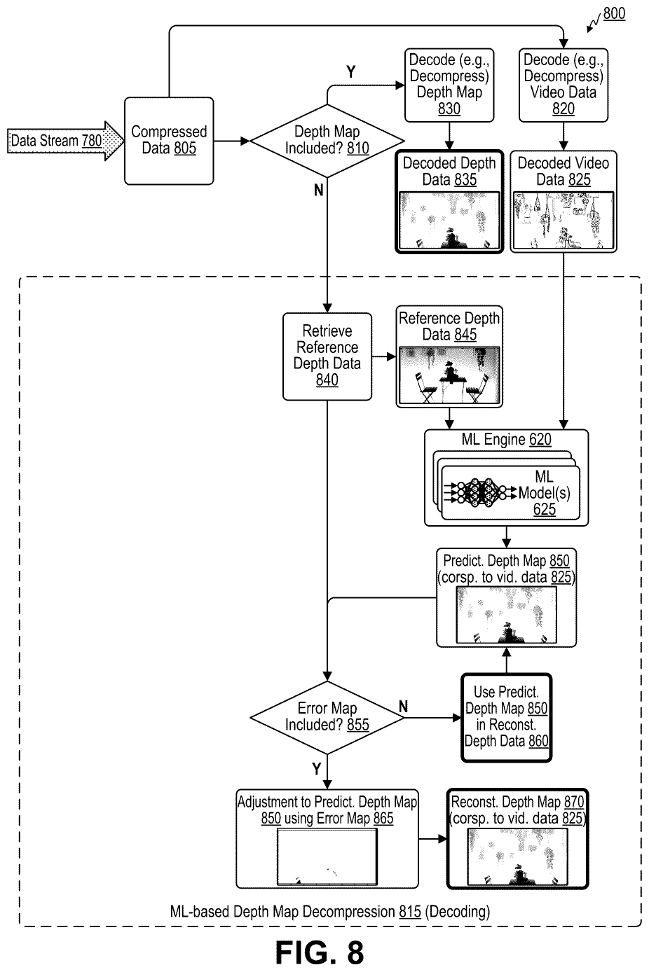

FIG. 8 is a flow diagram illustrating an example of a process 800 for decoding video data and/or depth data. The process 800 is performed by a decoder system, which may include the system 100, video source 102, the encoding device 104, decoding device 112, the communication link 120, the video destination device 122, the decoder system that reconstructs the reconstructed P frame depth map 515, the decoder system that reconstructs the reconstructed P frame depth map 525, the ML system 600, the ML engine 620, the ML model(s) 625, the encoder system that performs the process 700, the neural network 900, the codec system that performs the process 1000, the codec system that performs the process 1100, the computing system 1200 of FIG. 12, a computing device, a processor executing instructions stored in a memory, a processor executing instructions stored in a non-transitory computer-readable storage medium, a component of sub-system of any of these systems, a head-mounted display (HMD), a headset, a mobile handset, a wireless communication device, a wearable device, a component or system (e.g., a chipset, one or more processors such as one or more central processing units (CPUs), digital signal processors (DSPs), graphics processing units (GPUs), any combination thereof, and/or other type of processor(s), or other component or system) of any of the previously listed systems, or a combination thereof.

In the process 800, the decoder system receives the encoded data stream 780 (e.g., from the encoder system, from storage, or from a communication interface). The decoder system extracts compressed data 805 from the encoded data stream 780. The compressed data 805 can include a portion of the encoded data stream 780, for instance including one or more encoded (e.g., compressed) video frames, one or more encoded (e.g., compressed) depth maps corresponding (e.g., temporally, in terms of index or timestamp in the video) to the video frames, corresponding metadata, other types of data discussed herein as being included in the encoded data stream 780 (e.g., as in the data included in operation 755, operation 760, operation 765, and/or operation 770), or a combination thereof.

The decoder system identifies encoded (e.g., compressed) video data, and at operation 820, decodes (e.g., decompresses) the video data to generate decoded video data 825 (e.g., decompressed video data). In some examples, the decoded video data 825 refers to a specific decoded video frame.

The decoder system identifies, at operation 810, whether the compressed data 805 includes an encoded depth map (e.g., compressed depth map) corresponding to the decoded video data 825 (e.g., a depth map corresponding temporally to the decoded video frame of the decoded video data 825), for instance as in frames encoded using operation 770 of the process 700. If, at operation 810, the decoder system determines that the compressed data 805 includes an encoded depth map corresponding to the decoded video data 825 (e.g., a depth map corresponding temporally to the decoded video frame of the decoded video data 825, encoded using operation 770 of the process 700), then at operation 830, the decoder system decodes (e.g., decompresses) the encoded depth map to generate decoded depth data 835 (e.g., decompressed depth data). In some examples, the decompressed depth data 835 refers to a specific decoded depth map corresponding (e.g., temporally) to the decoded video frame of the decoded video data 825. In some examples, the decoder system outputs the decompressed depth data 835 as reconstructed depth data 860 output from the decoder system. In some examples, the decoder system outputs the 835 from the decoder system, for instance along with corresponding video data, for instance to play (e.g., on a 3D display such as an XR headset) or transmit (e.g., to a recipient device) a 3D video (e.g., a reconstruction of the 3D video data 705).

If, at operation 810, the decoder system determines that the compressed data 805 lacks (does not include) an encoded depth map (compressed depth map) corresponding to the decoded video data 825 (e.g., encoded using the operation 770), then the decoder system performs an ML-based depth map decompression 815. In some examples, if, at operation 810, the decoder system determines that the compressed data 805 lacks (does not include) an encoded depth map (compressed depth map) corresponding to the decoded video data 825 (e.g., encoded using the operation 770), then the compressed data 805 includes data from operation 755 (e.g., the indicator of the reference depth map) and/or data from operation 760 (e.g., the error map, error correction map, or a processed variant thereof).

At operation 840 of the ML-based depth map decompression 815, the decoder system retrieves reference depth data 845 (e.g., reference depth map 725), for instance based on the indicator of the reference depth map (e.g., from operation 755 of the process 700 for encoding). In some examples, at operation 840, the decoder system also retrieves reference video data (e.g., a reference video frame) corresponding (e.g., temporally) to the reference depth data 845 (e.g., a reference video frame corresponding to the reference depth map 725).

The decoder system processes the decoded video data 825 (e.g., video frame) and the reference depth data 845 (e.g., reference depth map) using the ML model(s) 625 to generate a predicted depth map 850 that corresponds (e.g., temporally) to the decoded video data 825 (e.g., video frame). The predicted depth map 850 can be an example of the prediction 635 and/or predicted depth map 730, or vice versa. In some examples, the decoder system processes the decoded video data 825 (e.g., video frame), the reference depth data 845 (e.g., reference depth map), and the reference video data (e.g., reference video frame) using the ML model(s) 625 to generate the predicted depth map 850 that corresponds (e.g., temporally) to the decoded video data 825 (e.g., video frame).

At operation 855 of the ML-based depth map decompression 815, the decoder system determines whether the compressed data 805 includes an error map or error correction map (e.g., as is encoded in operation 760). If, at operation 855, the decoder system determines that the compressed data 805 lacks (does not include) an error map or error correction map (e.g., indicating that the compressed data 805 was encoded using operation 755), then the decoder system uses the predicted depth map 850 as reconstructed depth data 860. In some examples, the decoder system outputs the reconstructed depth data 860 from the decoder system, for instance along with corresponding video data, for instance to (e.g., on a 3D display such as an XR headset) or transmit (e.g., to a recipient device) a 3D video (e.g., a reconstruction of the 3D video data 705).

If, at operation 855, the decoder system determines that the compressed data 805 includes an error map or error correction map (e.g., indicating that the compressed data 805 was encoded using operation 760), then the decoder system modifies and/or adjusts the predicted depth map 850 according to the error map or error correction map to generate a reconstructed depth data 870. In some examples, the decoder system outputs the reconstructed depth data 870 from the decoder system, for instance along with corresponding video data, for instance to (e.g., on a 3D display such as an XR headset) or transmit (e.g., to a recipient device) a 3D video (e.g., a reconstruction of the 3D video data 705).

In some examples, instead of using the ML model(s) 625 and/or the ML engine 620 to process the decoded video data 825 and the reference depth data 845 to generate the predicted depth map 850, another type of depth estimation algorithm is used to process the decoded video data 825 and/or the reference depth data 845 to generate the predicted depth map 850. For instance, examples of such a depth estimation algorithm (that is not the ML model(s) 625 and/or the ML engine 620) can include stereo vision algorithms, structure from motion algorithms, perspective projection algorithms, texture gradient analysis algorithms, occlusion relationship analysis algorithms, semantic segmentation algorithms, semantic mapping algorithms, or a combination thereof.

In some examples, the error map 865 can be calculated and/or generated using the ML model(s) 625, the ML engine 620, and/or another machine learning model system.

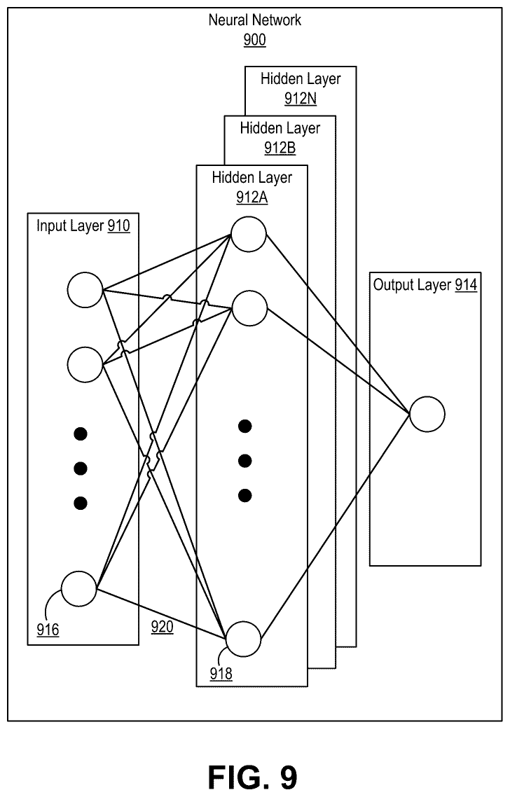

FIG. 9 is a block diagram illustrating an example of a neural network 900 that can be used for imaging operations. The neural network 900 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network. The neural network 900 may be, and/or may include, an example of the ML engine 620, the ML model(s) 625, another ML model discussed herein, another NN discussed herein, or a combination thereof.

An input layer 910 of the neural network 900 includes input data. The input data of the input layer 910 can include image(s) and/or video(s) and/or depth map(s) from the video source 102, encoded image(s) and/or video(s) and/or depth map(s) encoded by the encoding device 104, decoded image(s) and/or video(s) and/or depth map(s) decoded by the decoding device 112, image(s) and/or video(s) and/or depth map(s) stored and/or played on the video destination device 122, the texture data 410, the depth data 415, the I frame 420, the P frame 425, the I frame depth map 430, the P frame depth map 435, the depth map delta 440, the depth map delta 440 compressed with the lossless compression algorithm 450, the depth map delta 440 compressed with the lossy compression algorithm 455, the reconstructed P frame depth map 515, the reconstructed P frame depth map 525, video data 605, the depth data 610, the 3D video data 705, the video frame 720, the reference depth map 725, a reference video frame corresponding to the reference depth map 725, the encoded data stream 780, the compressed data 805, the decoded video data 825, the decompressed depth data 835, the reference depth data 845, reference video data corresponding to the reference depth data 845, the video frame of the process 1000, the reference depth map of the process 1000, a reference video frame corresponding to the reference depth map of the process 1000, the video frame of the process 1100, the reference depth map of the process 1100, a reference video frame corresponding to the reference depth map of the process 1100, other video frames, other depth maps, other images, semantic maps, surface normals, local planar priors, edge priors, other types of inputs discussed herein, or a combination thereof.

The neural network 900 includes multiple hidden layers 912, 912B, through 912N. The hidden layers 912, 912B, through 912N include “N” number of hidden layers, where “N” is an integer greater than or equal to one. The number of hidden layers can be made to include as many layers as needed for the given application. The neural network 900 further includes an output layer 914 that provides an output resulting from the processing performed by the hidden layers 912, 912B, through 912N.

In some examples, the output layer 914 can provide output data. The output data can include a predicted variant of the P frame depth map 435, the reconstructed P frame depth map 515, the reconstructed P frame depth map 525, the predicted depth map 630, the predicted depth map 730, the predicted depth map 850, a predicted depth map generated using the neural network 900, another predicted depth map discussed herein, the depth map delta 440, the error map 645, the error map 735, the error map 865, another error map discussed herein, other types of outputs discussed herein, or a combination thereof.

The neural network 900 is a multi-layer neural network of interconnected filters. Each filter can be trained to learn a feature representative of the input data. Information associated with the filters is shared among the different layers and each layer retains information as information is processed. In some cases, the neural network 900 can include a feed-forward network, in which case there are no feedback connections where outputs of the network are fed back into itself. In some cases, the network 900 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 910 can activate a set of nodes in the first hidden layer 912A. For example, as shown, each of the input nodes of the input layer 910 can be connected to each of the nodes of the first hidden layer 912A. The nodes of a hidden layer can transform the information of each input node by applying activation functions (e.g., filters) to this information. The information derived from the transformation can then be passed to and can activate the nodes of the next hidden layer 912B, which can perform their own designated functions. Example functions include convolutional functions, downscaling, upscaling, data transformation, and/or any other suitable functions. The output of the hidden layer 912B can then activate nodes of the next hidden layer, and so on. The output of the last hidden layer 912N can activate one or more nodes of the output layer 914, which provides a processed output image. In some cases, while nodes (e.g., node 916, node 918) in the neural network 900 are shown as having multiple output lines, a node has a single output and all lines shown as being output from a node represent the same output value. Lines between nodes (e.g., node 916, node 918), such as line 920, can represent connections and/or weights.

In some cases, each node or interconnection between nodes can have a weight that is a set of parameters derived from the training of the neural network 900. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

In some aspects, training of one or more of the machine learning systems or neural networks described herein can be performed using online training (e.g., in some case on-device training), offline training, and/or various combinations of online and offline training. In some cases, online may refer to time periods during which the input data (e.g., such as the input data discussed with respect to the input layer 910) is processed, for instance for generating output data (e.g., such as the input data discussed with respect to the output layer 914). In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

The neural network 900 is pre-trained to process the features from the data in the input layer 910 using the different hidden layers 912, 912B, through 912N in order to provide the output through the output layer 914.

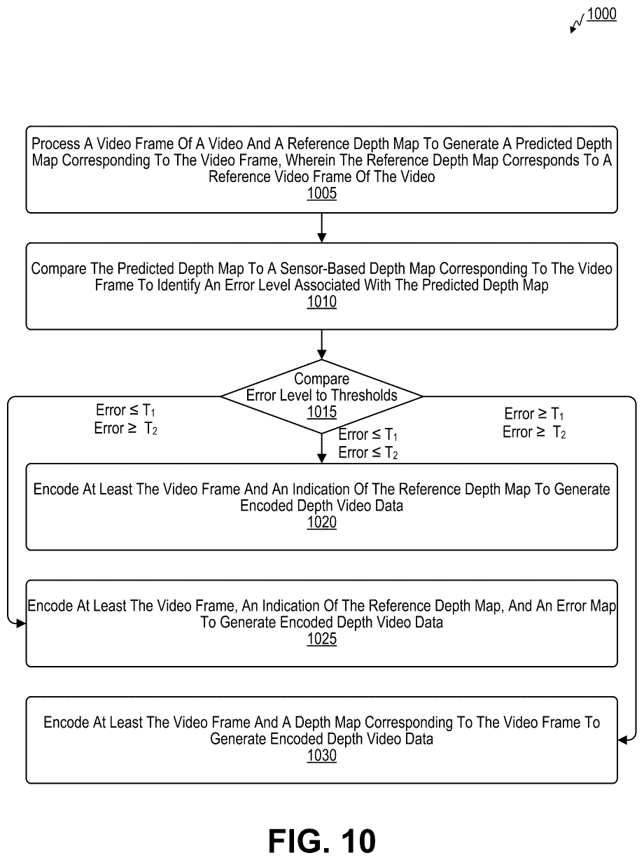

FIG. 10 is a flow chart illustrating an example of a process 1000 for encoding video data and/or depth data. The process 1000 can be performed by a codec system, which may include the system 100, video source 102, the encoding device 104, decoding device 112, the communication link 120, the video destination device 122, the decoder system that reconstructs the reconstructed P frame depth map 515, the decoder system that reconstructs the reconstructed P frame depth map 525, the ML system 600, the ML engine 620, the ML model(s) 625, the encoder system that performs the process 700, the decoder system that performs the process 800, the neural network 900, the codec system that performs the process 1100, the computing system 1200 of FIG. 12, a computing device, a processor executing instructions stored in a memory, a processor executing instructions stored in a non-transitory computer-readable storage medium, a component of sub-system of any of these systems, a head-mounted display (HMD), a headset, a mobile handset, a wireless communication device, a wearable device, a component or system (e.g., a chipset, one or more processors such as one or more central processing units (CPUs), digital signal processors (DSPs), graphics processing units (GPUs), any combination thereof, and/or other type of processor(s), or other component or system) of any of the previously listed systems, or a combination thereof.

At operation 1005, the codec system (or a component or subsystem thereof) is configured to, and can, process a video frame of a video and a reference depth map to generate a predicted depth map corresponding to the video frame. The reference depth map corresponds to a reference video frame of the video.

Examples of the video frame include a video frame of the video data from the video source 102, the I frame 420 the P frame 425, the video data 605, video data from the 3D video data 705, the video frame 720, the decoded video data 825, another video frame discussed herein, or a combination thereof. Examples of the reference depth map include the I frame depth map 430, the depth data 610, reference depth map data from the 3D video data 705, the reference depth map 725, the reference depth data 845, another depth map discussed herein, or a combination thereof. Examples of the predicted depth map include a predicted variant of the P frame depth map 435, the reconstructed P frame depth map 515, the reconstructed P frame depth map 525, the predicted depth map 630, the predicted depth map 730, the predicted depth map 850, a predicted depth map generated using the neural network 900, another predicted depth map discussed herein, or a combination thereof.

In some examples, the codec system (or a component or subsystem thereof) is configured to, and can, receive at least the video frame and the reference video frame of the video from an image sensor.

At operation 1010, in some examples, the codec system (or a component or subsystem thereof) is configured to, and can, compare the predicted depth map to a sensor-based depth map corresponding to the video frame to identify an error level associated with the predicted depth map. The sensor-based depth map is captured using a sensor. The sensor-based depth map can be referred to as a ground truth depth map. Examples of the sensor-based depth map include the I frame depth map 430, the P frame depth map 435, depth maps in the 3D video data 705, the reference depth map 725, the ground truth depth map 740, another ground truth depth map discussed herein, another sensor-based depth map discussed herein, or a combination thereof.

In some examples, the error level is associated with an error map, such as the depth map delta 440, the error map 645, the error map 735, the error map 865, another error map discussed herein, or a combination thereof. For instance, the error level can be an average (e.g., mean, median, and/or mode) error across the pixels of the error map, a sum of the errors across the pixels of the error map, a maximum error across the pixels of the error map, a minimum error across the pixels of the error map, or a combination thereof.

In some examples, the codec system (or a component or subsystem thereof) is configured to, and can, generate an error map based on the predicted depth map and a sensor-based depth map. The error map indicates differences between the predicted depth map and the sensor-based depth map. The codec system can determine the error level based on the error map.

In some examples, the codec system (or a component or subsystem thereof) is configured to, and can, and receive the sensor-based depth map and the reference depth map from the sensor. In some examples, the sensor is a depth sensor, such as a stereoscopic camera, a radio detection and ranging (RADAR) sensor, a light detection and ranging (LIDAR) sensor, a sound detection and ranging (SODAR) sensor, a sound navigation and ranging (SONAR) sensor, a laser rangefinder, a time of flight (ToF) sensor, a structured light sensor, another type of range sensor or depth sensor, or a combination thereof.

At operation 1015, in some examples, the codec system (or a component or subsystem thereof) is configured to, and can, compare the error level to one or more predetermined error level thresholds. The predetermined error level thresholds can include, for instance, a first threshold T₁ (e.g., as in the first threshold T₁ of operation 745) and a second threshold T₂ (e.g., as in the second threshold T₂ of operation 750).

If the error level is less than (or equal to) the first threshold T₁ and the error level is less than (or equal to) second threshold T₂, then operation 1015 is followed by operation 1020. If the error level is less than (or equal to) the first threshold T₁ and the error level is greater than (or equal to) second threshold T₂, then operation 1015 is followed by operation 1025. If the error level is greater than (or equal to) the first threshold T₁ and the error level is greater than (or equal to) second threshold T₂, then operation 1015 is followed by operation 1030.

At operation 1020, the codec system (or a component or subsystem thereof) is configured to, and can, encode the video frame and an indication of the reference depth map to generate encoded depth video data (e.g., to be compressed via data compression 775 and/or output by the encoder as part of the data stream 780). The video frame and/or the indication of the reference depth map can be referred to as information associated with generation of the predicted depth map.

In some examples, encoding of at least the video frame and the indication excludes encoding of additional error data (e.g., the error level of operation 1010, an error map as in operation 1025, and/or other error data) based on the comparison.

At operation 1025, the codec system (or a component or subsystem thereof) is configured to, and can, encode the video frame, the indication of the reference depth map, and an error map to generate encoded depth video data (e.g., to be compressed via data compression 775 and/or output by the encoder as part of the data stream 780). The video frame, the indication of the reference depth map, and/or the error map can be referred to as information associated with generation of the predicted depth map. The error map, as used in operation 1025, can refer to an error map and/or an error correction map.

In some examples, the codec system (or a component or subsystem thereof) can process (e.g., filter) the error map, so that the error map that is encoded as part of the operation 1025 is the processed error map.

At operation 1030, in some examples, the codec system (or a component or subsystem thereof) is configured to, and can, encode the video frame and a depth map corresponding to the video frame to generate encoded depth video data. Examples of the depth map corresponding to the video frame include the I frame depth map 430 (corresponding to the I frame 420), the P frame depth map 435 (corresponding to the P frame 425), and/or the ground truth depth map 740. The video frame and/or the depth map corresponding to the video frame can be referred to as information associated with generation of the predicted depth map.

In some examples, the indication of the reference depth map includes an index associated with the reference depth map. For instance, if the reference depth map is the I frame depth map 430, then the index would be index #819.

In some examples, encoding the video frame (in operation 1020, operation 1025, and/or operation 1030) includes encoding the video frame using at least temporal prediction (e.g., as in I frame 420 and/or P frame 425)

In some examples, the codec system (or a component or subsystem thereof) is configured to, and can, encode the video and corresponding depth data to generate an encoded dataset (e.g., encoded data stream 780, compressed data 805). The encoded dataset includes the encoded depth video data. The corresponding depth data includes the reference depth map. In some examples, the encoded dataset includes the reference video frame encoded using spatial prediction without temporal prediction (e.g., as in I frame 420). In some examples, the encoded dataset includes the reference depth map.

In some examples, processing the video frame and the reference depth map (as in operation 1005) includes processing the video frame and the reference depth map using a trained machine learning model that generates the predicted depth map. Examples of the trained machine learning model include the ML model(s) 625, the neural network 900, another ML model discussed herein, or a combination thereof. In some examples, the codec system (or a component or subsystem thereof) is configured to, and can, compare the predicted depth map to the sensor-based depth map (of operation 1010) to identify the error level associated with the predicted depth map, and update the trained machine learning model based on the error level (e.g., as feedback) to improve an accuracy of the trained machine learning model at depth map prediction.

In some examples, processing the video frame and the reference depth map (as in operation 1005) includes processing the video frame and the reference depth map using a depth estimation algorithm that generates the predicted depth map. Examples of the depth estimation algorithm include the ML model(s) 625, the ML engine 620, the neural network 900, stereo vision algorithms, structure from motion algorithms, perspective projection algorithms, texture gradient analysis algorithms, occlusion relationship analysis algorithms, semantic segmentation algorithms, semantic mapping algorithms, or a combination thereof.

In some examples, the codec system (or a component or subsystem thereof) is configured to, and can, process a second video frame of the video and the reference depth map to generate a second predicted depth map corresponding to the second video frame. The codec system can compare the second predicted depth map to a second sensor-based depth map corresponding to the second video frame to identify a second error level associated with the second predicted depth map. In response to the error level exceeding a predetermined error level, the codec system can encode at least the second video frame and the predicted depth map to generate second encoded depth video data (similarly to operation 1030). The codec system can combine the encoded depth video data and the second encoded depth video data to generate an encoded dataset.

In some examples, the codec system (or a component or subsystem thereof) is configured to, and can, store the encoded depth video data. In some examples, the codec system (or a component or subsystem thereof) is configured to, and can, send the encoded depth video data to a recipient device, such as a user device, a server, a decoder (e.g., decoding device 112), the decoder system that performs the process 800, the codec system that performs the process 1100, the computing system 1200, or a combination thereof. In some examples, the codec system (or a component or subsystem thereof) is configured to, and can, display at least one of the video or the depth data corresponding to the encoded depth video data (e.g., using a display screen, such as a 3D display screen, a HMD, and/or an XR device).

The process 1000 can improve efficiency of 3D video encoding by reducing the amount of depth data that needs to be encoded to encode the 3D video. For instance, when the predicted depth map of operation 1005 (generated by the trained machine learning model or another depth estimation algorithm) is sufficiently accurate (e.g., as determined based on the comparison of the error level to the threshold(s) in operation 1015), the codec system does not need to send full depth data for a given frame (e.g., as in operation 1020 and operation 1025). Even if error map data is sent (e.g., as in operation 1025), error map data takes up less space than full depth data, or a depth map delta. This can provide technical improvements in efficiency, bandwidth reductions, throughput improvements, reductions in storage space used, improved video quality (e.g., by freeing up more space for higher-resolution video data), or a combination thereof.

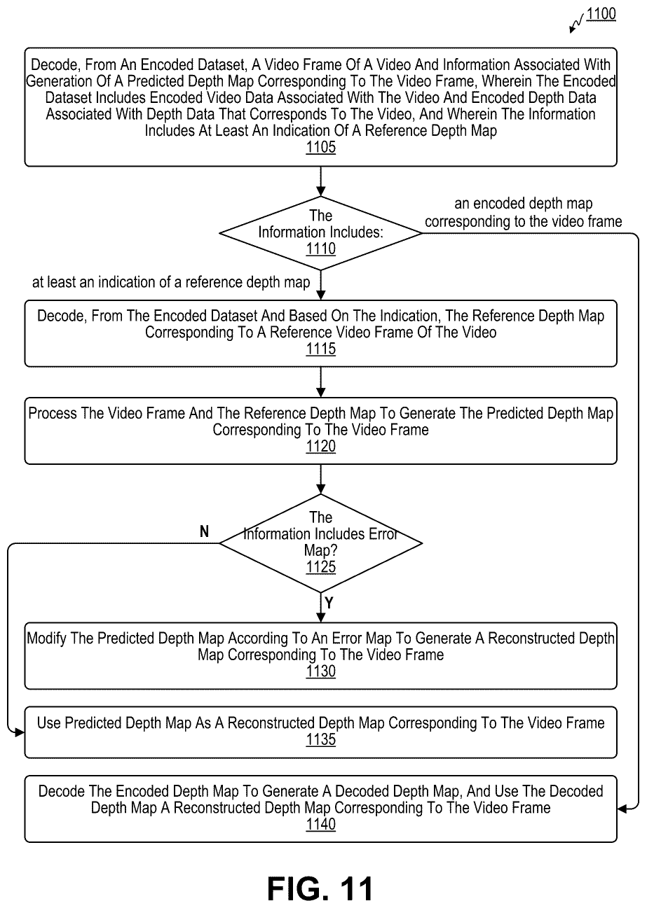

FIG. 11 is a flow chart illustrating an example of a process 1100 for decoding video data and/or depth data. The process 1100 can be performed by a codec system, which may include the system 100, video source 102, the encoding device 104, decoding device 112, the communication link 120, the video destination device 122, the decoder system that reconstructs the reconstructed P frame depth map 515, the decoder system that reconstructs the reconstructed P frame depth map 525, the ML system 600, the ML engine 620, the ML model(s) 625, the encoder system that performs the process 700, the decoder system that performs the process 800, the neural network 900, the codec system that performs the process 1000, the computing system 1200 of FIG. 12, a computing device, a processor executing instructions stored in a memory, a processor executing instructions stored in a non-transitory computer-readable storage medium, a component of sub-system of any of these systems, a head-mounted display (HMD), a headset, a mobile handset, a wireless communication device, a wearable device, a component or system (e.g., a chipset, one or more processors such as one or more central processing units (CPUs), digital signal processors (DSPs), graphics processing units (GPUs), any combination thereof, and/or other type of processor(s), or other component or system) of any of the previously listed systems, or a combination thereof.

At operation 1105, the codec system (or a component or subsystem thereof) is configured to, and can, decode, from an encoded dataset, decode, from an encoded dataset (e.g., encoded data stream 780, compressed data 805), a video frame of a video and information associated with generation of a predicted depth map corresponding to the video frame. The encoded dataset includes encoded video data associated with the video and encoded depth data associated with depth data that corresponds to the video.

Examples of the video frame include a video frame of the video data from the video source 102, the I frame 420 the P frame 425, the video data 605, video data from the 3D video data 705, the video frame 720, the decoded video data 825, another video frame discussed herein, or a combination thereof. Examples of the reference depth map include the I frame depth map 430, the depth data 610, reference depth map data from the 3D video data 705, the reference depth map 725, the reference depth data 845, another depth map discussed herein, or a combination thereof.

In some examples, the indication of the reference depth map includes an index associated with the reference depth map. For instance, if the reference depth map is the I frame depth map 430, then the index would be index #819.

In some examples, the codec system (or a component or subsystem thereof) is configured to, and can, receive the encoded dataset from an encoder (e.g., encoding device 104, the codec system that performs the process 1000, the computing system 1200).

At operation 1110, in some examples, the codec system (or a component or subsystem thereof) is configured to, and can, identify what the information (associated with generation of the predicted depth map corresponding to the video frame) includes. If the information includes at least an indication of the reference depth map (e.g., as in operation 1020 and/or operation 1025), then operation 1110 is followed by operation 1115. If the information includes at least an encoded depth map corresponding to the video frame (e.g., as in operation 1030), then operation 1110 is followed by operation 1140.

At operation 1115, the codec system (or a component or subsystem thereof) is configured to, and can, decode, from the encoded dataset and based on the indication, the reference depth map corresponding to a reference video frame of the video.

At operation 1120, the codec system (or a component or subsystem thereof) is configured to, and can, process the video frame and the information (e.g., the indication of the reference depth map) to generate the predicted depth map corresponding to the video frame.

Examples of the predicted depth map include a predicted variant of the P frame depth map 435, the reconstructed P frame depth map 515, the reconstructed P frame depth map 525, the predicted depth map 630, the predicted depth map 730, the predicted depth map 850, a predicted depth map generated using the neural network 900, another predicted depth map discussed herein, or a combination thereof.

At operation 1125, in some examples, the codec system (or a component or subsystem thereof) is configured to, and can, identify whether the information (associated with generation of the predicted depth map corresponding to the video frame) includes an error map and/or error correction map. If the information includes an error map and/or error correction map (e.g., as in operation 1025), then operation 1125 is followed by operation 1130. If the information lacks (does not include) an error map and/or error correction map (e.g., as in operation 1020), then operation 1125 is followed by operation 1135. Examples of the error map, and/or error correction map, include the depth map delta 440, the error map 645, the error map 735, the error map 865, another error map discussed herein, or a combination thereof.

At operation 1130, in some examples, the codec system (or a component or subsystem thereof) is configured to, and can, modify the predicted depth map (generated in operation 1120) according to the error map and/or error correction map to generate a reconstructed depth map corresponding to the video frame (e.g., to use as the output of the codec system, as in the reconstructed depth data 870).

At operation 1135, in some examples, the codec system (or a component or subsystem thereof) is configured to, and can, use the predicted depth map (generated in operation 1120) as a reconstructed depth map corresponding to the video frame (e.g., to use as the output of the codec system, as in the reconstructed depth data 860).

At operation 1140, in some examples, the codec system (or a component or subsystem thereof) is configured to, and can, decode the encoded depth map to generate a decoded depth map, and use the decoded depth map as a reconstructed depth map corresponding to the video frame (e.g., to use as the output of the codec system, as in the decompressed depth data 835).

In some examples, processing the video frame and the information (e.g., the indication of the reference depth map) to generate the predicted depth map (e.g., as in operation 1120) includes processing the video frame and the information using a trained machine learning model that generates the predicted depth map. Examples of the trained machine learning model include the ML model(s) 625, the ML engine 620, the neural network 900, another trained machine learning model discussed herein, or a combination thereof. In some examples, the codec system (or a component or subsystem thereof) is configured to, and can, update the trained machine learning model based on feedback associated with the predicted depth map (e.g., based on the error map of operation 1125 and/or operation 1130) to improve an accuracy of the trained machine learning model at depth map prediction.

In some examples, processing the video frame and the information (e.g., the indication of the reference depth map) to generate the predicted depth map (e.g., as in operation 1120) includes processing the video frame and the information using a depth estimation algorithm that generates the predicted depth map. Examples of the depth estimation algorithm include the ML model(s) 625, the ML engine 620, the neural network 900, stereo vision algorithms, structure from motion algorithms, perspective projection algorithms, texture gradient analysis algorithms, occlusion relationship analysis algorithms, semantic segmentation algorithms, semantic mapping algorithms, or a combination thereof.

In some examples, the codec system (or a component or subsystem thereof) is configured to, and can, decode the video from the encoded video data. The video includes the video frame and the reference video frame. In some examples, the codec system can decode depth data from the encoded depth data. The depth data includes the predicted depth map and the reference depth map.

In some examples, the codec system (or a component or subsystem thereof) is configured to, and can, store the video and the depth data. In some examples, the codec system (or a component or subsystem thereof) is configured to, and can, send the video and the depth data to a recipient device, such as a user device, a server, and/or a computing system 1200. In some examples, the codec system (or a component or subsystem thereof) is configured to, and can, display at least one of the video or the depth data (e.g., using a display screen, such as a 3D display screen, a AMD, and/or an XR device).

In some examples, the encoded depth data includes the information in encoded form without including a sensor-based depth map corresponding to the video frame. The sensor-based depth map can be referred to as a ground truth depth map. Examples of the sensor-based depth map include the I frame depth map 430, the P frame depth map 435, depth maps in the 3D video data 705, the reference depth map 725, the ground truth depth map 740, another ground truth depth map discussed herein, another sensor-based depth map discussed herein, or a combination thereof.

In some examples, the encoded video data includes the video frame encoded using at least temporal prediction (e.g., as in I frame 420 and/or P frame 425). In some examples, the encoded video data includes the reference video frame encoded using spatial prediction without temporal prediction (e.g., as in I frame 420).

Examples of the encoded video frame data can include video data encoded by an encoder (e.g., encoding device 104, encoder engine 106), encoded video data output via the output 110, encoded video data received via the input 114, encoded video data transferred via the communication link 120, encoded video data received via a network entity 79,

Examples of the decoded video frame can include video data decoded using a decoder (e.g., decoding device 112, decoder engine 116), decoded video data sent to and/or received by a video destination device 122, the decoded video data 825, or a combination thereof.

The process 1100 can improve efficiency of 3D video decoding by reducing the amount of depth data that needs to be provided to a decoder to decode the 3D video. For instance, where the predicted depth map (e.g., generated by the trained ML model and/or depth estimation algorithm) is sufficiently accurate, the decoder can generate the reconstructed depth map using only the video frame and the reference depth map (e.g., at operation 1120 and/or operation 1135). In some cases, if error map data is present in the encoded data, the decoder can generate the reconstructed depth map using only the video frame, the reference depth map, and the error map (e.g., as in operation 1120 and operation 1130). Even if error map data is used (e.g., as in operation 1130), error map data takes up less space than full depth data, or a depth map delta. This can provide technical improvements in efficiency, bandwidth reductions, throughput improvements, reductions in storage space used, improved video quality (e.g., by freeing up more space for higher-resolution video data), or a combination thereof. The ability of the decoder to generate reconstructed depth data for a video frame without being provided actual depth data for the video frame can also aid in error handling and/or error correction, for example allowing the decoder to still generate reconstructed depth data in situations where depth data is included but includes error(s), or to still generate reconstructed depth data in situations where depth data was omitted due to an error.

The process 700, the process 800, the process 1000, the process 1100, and/or other processes described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700, the process 800, the process 1000, and the process 1100, and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a block diagram illustrating an example of a computing system 1200 that can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing system 1200 may include, implement, or be included in any or all of the encoding device 104 of FIG. 1 and/or FIG. 2, another video source-side device or video transmission device, the decoding device 112 of FIG. 1 and/or FIG. 3, another client-side device, such as a player device, a display, or any other client-side device, the decoder system that reconstructs the reconstructed P frame depth map 515, the decoder system that reconstructs the reconstructed P frame depth map 525, the ML system 600, the ML engine 620, the ML model(s) 625, the encoder system that performs the process 700, the decoder system that performs the process 800, the neural network 900, the codec system that performs the process 1000, the codec system that performs the process 1100 of FIG. 11, or a combination thereof. Additionally or alternatively, the computing system 1200 may be configured to perform process 1000 of FIG. 10, and/or other process described herein.

In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory (e.g., memory unit 1215), such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LIDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus to coding of video data with corresponding depth data, the apparatus comprising: at least one memory; and at least one processor coupled to the at least one memory, wherein the at least one processor is configured to: process a video frame of a video and a reference depth map to generate a predicted depth map corresponding to the video frame, wherein the reference depth map corresponds to a reference video frame of the video; and encode at least the video frame and an indication of the reference depth map to generate encoded depth video data.

Aspect 2. The apparatus of Aspect 1, wherein the indication of the reference depth map includes an index associated with the reference depth map.

Aspect 3. The apparatus of any one of Aspects 1 to 2, wherein the at least one processor is configured to: compare the predicted depth map to a sensor-based depth map corresponding to the video frame to identify an error level associated with the predicted depth map, wherein the sensor-based depth map is captured using a sensor, and wherein the encoding of at least the video frame and the indication is responsive to a comparison between the error level and a predetermined error threshold.

Aspect 4. The apparatus of Aspect 3, wherein the encoding of at least the video frame and the indication excludes encoding of additional error data based on the comparison.

Aspect 5. The apparatus of any one of Aspects 3 to 4, wherein the encoding of at least the video frame and the indication includes encoding an error map based on the comparison.

Aspect 6. The apparatus of any one of Aspects 3 to 5, wherein the at least one processor is configured to: receive at least the video frame and the reference video frame of the video from an image sensor; and receive the sensor-based depth map and the reference depth map from the sensor, wherein the sensor is a depth sensor.

Aspect 7. The apparatus of any one of Aspects 1 to 6, wherein the at least one processor is configured to: generate an error map based on the predicted depth map and a sensor-based depth map, wherein the sensor-based depth map is captured using a sensor, and wherein the error map indicates differences between the predicted depth map and the sensor-based depth map; and determine an error level based on the error map, wherein the encoding of at least the video frame and the indication is responsive to a comparison between the error level and a predetermined error threshold.

Aspect 8. The apparatus of Aspect 7, wherein the encoding of at least the video frame and the indication includes encoding at least the video frame, the indication, and the error map.

Aspect 9. The apparatus of any one of Aspects 7 to 8, wherein the at least one processor is configured to: process the error map to generate a processed error map, wherein the encoding of at least the video frame and the indication includes encoding at least the video frame, the indication, and the processed error map.

Aspect 10. The apparatus of any one of Aspects 1 to 9, wherein, to encode the video frame, the at least one processor is configured to: encode the video frame using at least temporal prediction.

Aspect 11. The apparatus of any one of Aspects 1 to 10, wherein the at least one processor is configured to: encode the video and corresponding depth data to generate an encoded dataset, wherein the encoded dataset includes the encoded depth video data, and wherein the corresponding depth data includes the reference depth map.

Aspect 12. The apparatus of Aspect 11, wherein the encoded dataset includes the reference video frame encoded using spatial prediction without temporal prediction, and wherein the encoded dataset includes the reference depth map.

Aspect 13. The apparatus of any one of Aspects 1 to 12, wherein, to process the video frame and the reference depth map, the at least one processor is configured to process the video frame and the reference depth map using a trained machine learning model that generates the predicted depth map.

Aspect 14. The apparatus of Aspect 13, wherein the at least one processor is configured to: compare the predicted depth map to a sensor-based depth map corresponding to the video frame to identify an error level associated with the predicted depth map; and update the trained machine learning model based on the error level to improve an accuracy of the trained machine learning model at depth map prediction.

Aspect 15. The apparatus of any one of Aspects 1 to 14, wherein the at least one processor is configured to: process a second video frame of the video and the reference depth map to generate a second predicted depth map corresponding to the second video frame; compare the second predicted depth map to a sensor-based depth map corresponding to the second video frame to identify an error level associated with the second predicted depth map; in response to the error level exceeding a predetermined error level, encode at least the second video frame and the predicted depth map to generate second encoded depth video data; and combine the encoded depth video data and the second encoded depth video data to generate an encoded dataset.

Aspect 16. A method for coding of video data with corresponding depth data, the method comprising: processing a video frame of a video and a reference depth map to generate a predicted depth map corresponding to the video frame, wherein the reference depth map corresponds to a reference video frame of the video; and encoding the video frame an indication of the reference depth map to generate encoded depth video data.

Aspect 17. The method of Aspect 16, wherein the indication of the reference depth map includes an index associated with the reference depth map.

Aspect 18. The method of any one of Aspects 16 to 17, further comprising: comparing the predicted depth map to a sensor-based depth map corresponding to the video frame to identify an error level associated with the predicted depth map, wherein the sensor-based depth map is captured using a sensor, and wherein the encoding of at least the video frame and the indication is responsive to a comparison between the error level and a predetermined error threshold.

Aspect 19. The method of Aspect 18, wherein the encoding of at least the video frame and the indication excludes encoding of additional error data based on the comparison.

Aspect 20. The method of any one of Aspects 18 to 19, wherein the encoding of at least the video frame and the indication includes encoding an error map based on the comparison.

Aspect 21. The method of any one of Aspects 18 to 20, further comprising: receiving at least the video frame and the reference video frame of the video from an image sensor; and receiving the sensor-based depth map and the reference depth map from the sensor, wherein the sensor is a depth sensor.

Aspect 22. The method of any one of Aspects 16 to 21, further comprising: generating an error map based on the predicted depth map and a sensor-based depth map, wherein the sensor-based depth map is captured using a sensor, and wherein the error map indicates differences between the predicted depth map and the sensor-based depth map; and determining an error level based on the error map, wherein the encoding of at least the video frame and the indication is responsive to a comparison between the error level and a predetermined error threshold.

Aspect 23. The method of Aspect 22, wherein the encoding of at least the video frame and the indication includes encoding at least the video frame, the indication, and the error map.

Aspect 24. The method of any one of Aspects 22 to 23, further comprising: processing the error map to generate a processed error map, wherein the encoding of at least the video frame and the indication includes encoding at least the video frame, the indication, and the processed error map.

Aspect 25. The method of any one of Aspects 16 to 24, wherein encoding the video frame includes encoding the video frame using at least temporal prediction.

Aspect 26. The method of any one of Aspects 16 to 25, further comprising: encoding the video and corresponding depth data to generate an encoded dataset, wherein the encoded dataset includes the encoded depth video data, and wherein the corresponding depth data includes the reference depth map.

Aspect 27. The method of Aspect 26, wherein the encoded dataset includes the reference video frame encoded using spatial prediction without temporal prediction, and wherein the encoded dataset includes the reference depth map.

Aspect 28. The method of any one of Aspects 16 to 27, wherein processing the video frame and the reference depth map includes processing the video frame and the reference depth map using a trained machine learning model that generates the predicted depth map.

Aspect 29. The method of Aspect 28, further comprising: comparing the predicted depth map to a sensor-based depth map corresponding to the video frame to identify an error level associated with the predicted depth map; and updating the trained machine learning model based on the error level to improve an accuracy of the trained machine learning model at depth map prediction.

Aspect 30. The method of any one of Aspects 16 to 29, further comprising: processing a second video frame of the video and the reference depth map to generate a second predicted depth map corresponding to the second video frame; comparing the second predicted depth map to a sensor-based depth map corresponding to the second video frame to identify an error level associated with the second predicted depth map; in response to the error level exceeding a predetermined error level, encoding at least the second video frame and the predicted depth map to generate second encoded depth video data; and combining the encoded depth video data and the second encoded depth video data to generate an encoded dataset.

Aspect 31. An apparatus for coding of video data with corresponding depth data, the apparatus comprising: at least one memory; and at least one processor coupled to the at least one memory, wherein the at least one processor is configured to: decode, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map; decode, from the encoded dataset and based on the indication, the reference depth map corresponding to a reference video frame of the video; and process the video frame and the reference depth map corresponding to the information to generate the predicted depth map corresponding to the video frame.

Aspect 32. The apparatus of Aspect 31, wherein the at least one processor is configured to: decode the video from the encoded video data, wherein the video includes the video frame and the reference video frame; and decode depth data from the encoded depth data, wherein the depth data includes the predicted depth map and the reference depth map.

Aspect 33. The apparatus of Aspect 32, wherein the at least one processor is configured to: store the video and the depth data.

Aspect 34. The apparatus of any one of Aspects 32 to 33, wherein the at least one processor is configured to: send the video and the depth data to a recipient device.

Aspect 35. The apparatus of any one of Aspects 32 to 34, wherein the at least one processor is configured to: display at least one of the video or the depth data.

Aspect 36. The apparatus of any one of Aspects 31 to 35, wherein the encoded depth data includes the information in encoded form without including a sensor-based depth map corresponding to the video frame.

Aspect 37. The apparatus of any one of Aspects 31 to 36, wherein the encoded video data includes the video frame encoded using at least temporal prediction.

Aspect 38. The apparatus of any one of Aspects 31 to 37, wherein the encoded video data includes the reference video frame encoded using spatial prediction without temporal prediction.

Aspect 39. The apparatus of any one of Aspects 31 to 38, wherein the at least one processor is configured to: modify the predicted depth map according to an error map, wherein the information includes the error map.

Aspect 40. The apparatus of any one of Aspects 31 to 39, wherein the at least one processor is configured to: receive the encoded dataset from an encoder.

Aspect 41. The apparatus of any one of Aspects 31 to 40, wherein the indication of the reference depth map includes an index associated with the reference depth map.

Aspect 42. The apparatus of any one of Aspects 31 to 41, wherein, to process the video frame and the reference depth map, the at least one processor is configured to process the video frame and the reference depth map using a trained machine learning model that generates the predicted depth map.

Aspect 43. The apparatus of Aspect 42, wherein the at least one processor is configured to: update the trained machine learning model based on feedback associated with the predicted depth map to improve an accuracy of the trained machine learning model at depth map prediction.

Aspect 44. A method for coding of video data with corresponding depth data, the method comprising: decoding, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map; decoding, from the encoded dataset and based on the indication, the reference depth map corresponding to a reference video frame of the video; and processing the video frame and the reference depth map corresponding to the information using a trained machine learning model to generate the predicted depth map corresponding to the video frame.

Aspect 45. The method of Aspect 44, further comprising: decoding the video from the encoded video data, wherein the video includes the video frame and the reference video frame; and decoding depth data from the encoded depth data, wherein the depth data includes the predicted depth map and the reference depth map.

Aspect 46. The method of Aspect 45, further comprising: storing the video and the depth data.

Aspect 47. The method of any one of Aspects 45 to 46, further comprising: sending the video and the depth data to a recipient device.

Aspect 48. The method of any one of Aspects 45 to 47, further comprising: displaying at least one of the video or the depth data.

Aspect 49. The method of any one of Aspects 44 to 48, wherein the encoded depth data includes the information in encoded form without including a sensor-based depth map corresponding to the video frame.

Aspect 50. The method of any one of Aspects 44 to 49, wherein the encoded video data includes the video frame encoded using at least temporal prediction.

Aspect 51. The method of any one of Aspects 44 to 50, wherein the encoded video data includes the reference video frame encoded using spatial prediction without temporal prediction.

Aspect 52. The method of any one of Aspects 44 to 51, further comprising: modifying the predicted depth map according to an error map, wherein the information includes the error map.

Aspect 53. The method of any one of Aspects 44 to 52, further comprising: receiving the encoded dataset from an encoder.

Aspect 54. The method of any one of Aspects 44 to 53, wherein the indication of the reference depth map includes an index associated with the reference depth map.

Aspect 55. The method of any one of Aspects 44 to 54, wherein processing the video frame and the reference depth map includes processing the video frame and the reference depth map using a trained machine learning model that generates the predicted depth map.

Aspect 56. The method of Aspect 55, further comprising: updating the trained machine learning model based on feedback associated with the predicted depth map to improve an accuracy of the trained machine learning model at depth map prediction.

Aspect 57. A non-transitory computer-readable medium having stored thereon instructions that, when executed by one or more processors, cause the one or more processors to perform operations according to any of Aspects 1 to 56.

Aspect 58. An apparatus comprising one or more means for performing operations according to any of Aspects 1 to 56.

What is claimed is:

1. An apparatus for coding of video data with corresponding depth data, the apparatus comprising:
at least one memory; and
at least one processor coupled to the at least one memory, wherein the at least one processor is configured to:
process a video frame of a video and a reference depth map to generate a predicted depth map corresponding to the video frame, wherein the reference depth map corresponds to a reference video frame of the video; and
encode at least the video frame and an indication of the reference depth map to generate encoded depth video data.

2. The apparatus of claim 1, wherein the indication of the reference depth map includes an index associated with the reference depth map.

3. The apparatus of claim 1, wherein the at least one processor is configured to:
compare the predicted depth map to a sensor-based depth map corresponding to the video frame to identify an error level associated with the predicted depth map, wherein the sensor-based depth map is captured using a sensor, and wherein the encoding of at least the video frame and the indication is responsive to a comparison between the error level and a predetermined error threshold.

4. The apparatus of claim 3, wherein the encoding of at least the video frame and the indication excludes encoding of additional error data based on the comparison.

5. The apparatus of claim 3, wherein the encoding of at least the video frame and the indication includes encoding an error map based on the comparison.

6. The apparatus of claim 3, wherein the at least one processor is configured to:
receive at least the video frame and the reference video frame of the video from an image sensor; and
receive the sensor-based depth map and the reference depth map from the sensor, wherein the sensor is a depth sensor.

7. The apparatus of claim 1, wherein the at least one processor is configured to:
generate an error map based on the predicted depth map and a sensor-based depth map, wherein the sensor-based depth map is captured using a sensor, and wherein the error map indicates differences between the predicted depth map and the sensor-based depth map; and
determine an error level based on the error map, wherein the encoding of at least the video frame and the indication is responsive to a comparison between the error level and a predetermined error threshold.

8. The apparatus of claim 7, wherein the encoding of at least the video frame and the indication includes encoding at least the video frame, the indication, and the error map.

9. The apparatus of claim 7, wherein the at least one processor is configured to:
process the error map to generate a processed error map, wherein the encoding of at least the video frame and the indication includes encoding at least the video frame, the indication, and the processed error map.

10. The apparatus of claim 1, wherein, to encode the video frame, the at least one processor is configured to:
encode the video frame using at least temporal prediction.

11. The apparatus of claim 1, wherein the at least one processor is configured to:
encode the video and corresponding depth data to generate an encoded dataset, wherein the encoded dataset includes the encoded depth video data, and wherein the corresponding depth data includes the reference depth map.

12. The apparatus of claim 11, wherein the encoded dataset includes the reference video frame encoded using spatial prediction without temporal prediction, and wherein the encoded dataset includes the reference depth map.

13. The apparatus of claim 1, wherein, to process the video frame and the reference depth map, the at least one processor is configured to process the video frame and the reference depth map using a trained machine learning model that generates the predicted depth map.

14. The apparatus of claim 13, wherein the at least one processor is configured to:
compare the predicted depth map to a sensor-based depth map corresponding to the video frame to identify an error level associated with the predicted depth map; and
update the trained machine learning model based on the error level to improve an accuracy of the trained machine learning model at depth map prediction.

15. The apparatus of claim 1, wherein the at least one processor is configured to:
process a second video frame of the video and the reference depth map to generate a second predicted depth map corresponding to the second video frame;
compare the second predicted depth map to a sensor-based depth map corresponding to the second video frame to identify an error level associated with the second predicted depth map;
in response to the error level exceeding a predetermined error level, encode at least the second video frame and the predicted depth map to generate second encoded depth video data; and
combine the encoded depth video data and the second encoded depth video data to generate an encoded dataset.

16. A method for coding of video data with corresponding depth data, the method comprising:
processing a video frame of a video and a reference depth map to generate a predicted depth map corresponding to the video frame, wherein the reference depth map corresponds to a reference video frame of the video; and
encoding the video frame an indication of the reference depth map to generate encoded depth video data.

17. An apparatus for coding of video data with corresponding depth data, the apparatus comprising:
at least one memory; and
at least one processor coupled to the at least one memory, wherein the at least one processor is configured to:
decode, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map;
decode, from the encoded dataset and based on the indication, the reference depth map corresponding to a reference video frame of the video; and
process the video frame and the reference depth map corresponding to the information to generate the predicted depth map corresponding to the video frame.

18. The apparatus of claim 17, wherein the at least one processor is configured to:
decode the video from the encoded video data, wherein the video includes the video frame and the reference video frame; and
decode depth data from the encoded depth data, wherein the depth data includes the predicted depth map and the reference depth map.

19. The apparatus of claim 18, wherein the at least one processor is configured to:
store the video and the depth data.

20. The apparatus of claim 18, wherein the at least one processor is configured to:
send the video and the depth data to a recipient device.

21. The apparatus of claim 18, wherein the at least one processor is configured to:
display at least one of the video or the depth data.

22. The apparatus of claim 17, wherein the encoded depth data includes the information in encoded form without including a sensor-based depth map corresponding to the video frame.

23. The apparatus of claim 17, wherein the encoded video data includes the video frame encoded using at least temporal prediction.

24. The apparatus of claim 17, wherein the encoded video data includes the reference video frame encoded using spatial prediction without temporal prediction.

25. The apparatus of claim 17, wherein the at least one processor is configured to:
modify the predicted depth map according to an error map, wherein the information includes the error map.

26. The apparatus of claim 17, wherein the at least one processor is configured to:
receive the encoded dataset from an encoder.

27. The apparatus of claim 17, wherein the indication of the reference depth map includes an index associated with the reference depth map.

28. The apparatus of claim 17, wherein, to process the video frame and the reference depth map, the at least one processor is configured to process the video frame and the reference depth map using a trained machine learning model that generates the predicted depth map.

29. The apparatus of claim 28, wherein the at least one processor is configured to:
update the trained machine learning model based on feedback associated with the predicted depth map to improve an accuracy of the trained machine learning model at depth map prediction.

30. A method for coding of video data with corresponding depth data, the method comprising:
decoding, from an encoded dataset, a video frame of a video and information associated with generation of a predicted depth map corresponding to the video frame, wherein the encoded dataset includes encoded video data associated with the video and encoded depth data associated with depth data that corresponds to the video, and wherein the information includes at least an indication of a reference depth map;
decoding, from the encoded dataset and based on the indication, the reference depth map corresponding to a reference video frame of the video; and
processing the video frame and the reference depth map corresponding to the information using a trained machine learning model to generate the predicted depth map corresponding to the video frame.
